(19) United States
(12) Patent Application Publication
(10) Pub. No.: US 2023/0238549 A1
(43) Pub. Date: Jul. 27, 2023

(54) FUEL CELL MODULE

(71) Applicant: DENSO CORPORATION, Kariya-City (JP)

(72) Inventors: Yasuhiro OSADA, Kariya-City (JP); Takashi OJIRO, Kariya-City (JP); Atsushi HAYASAKA, Kariya-City (JP); Reona INAGAKI, Kariya-City (JP)

(21) Appl. No.: 18/192,527

(22) Filed: Mar. 29, 2023

Related U.S. Application Data
(63) Continuation of application No. PCT/JP2021/042609, filed on Nov. 19, 2021.

(30) Foreign Application Priority Data
Dec. 1, 2020 (JP) 2020-199653
Jul. 16, 2021 (JP) 2021-118225

(51) Int. Cl. H01M 8/04014; H01M 8/249; H01M 8/04701; H01M 8/04225

(52) U.S. Cl. CPC H01M 8/04014; H01M 8/249; H01M 8/04738; H01M 8/04716; H01M 8/04225

(57) ABSTRACT

A fuel cell module includes: a cell stack in which fuel cells are stacked; and a stack temperature controller through which the oxidant gas before being supplied to the cell stack flows. The fuel cell module includes a warm-up burner that produces combustion gas for warming the cell stack. The warm-up burner is arranged outside a housing space in which the cell stack is housed. The stack temperature controller is arranged to face the cell stack with a predetermined gap therebetween so as to exchange heat with the cell stack. The stack temperature controller is located adjacent to a combustion gas passage through which the combustion gas generated by the warm-up burner flows so as to allow heat exchange between the oxidant gas flowing through the stack temperature controller and the combustion gas generated by the warm-up burner.

### CROSS REFERENCE TO RELATED APPLICATIONS

The present application is a continuation application of International Patent Application No. PCT/JP2021/042609 filed on Nov. 19, 2021, which designated the U.S. and claims the benefit of priority from Japanese Patent Application No. 2020-199653 filed on Dec. 1, 2020 and Japanese Patent Application No. 2021-118225 filed on Jul. 16, 2021. The entire disclosures of all of the above applications are incorporated herein by reference.

### TECHNICAL FIELD

The present disclosure relates to a fuel cell module.

### BACKGROUND

A fuel cell module has a starting burner arranged inside a fuel cell including a stack of fuel cells. The fuel cells can be efficiently heated by heat radiation and conduction from the starting burner.

### SUMMARY

According to an aspect of the present disclosure, a fuel cell module includes: a cell stack in which a plurality of fuel cells are stacked so as to output electrical energy through an electrochemical reaction between a fuel gas and an oxidant gas; a stack temperature controller through which the oxidant gas before being supplied to the cell stack flows; and a warm-up burner configured to generate combustion gas to warm up the cell stack. The warm-up burner is arranged outside a housing space in which the cell stack is arranged. The stack temperature controller is arranged to face the cell stack with a predetermined gap therebetween so as to allow heat exchange with the cell stack, and is located adjacent to a combustion gas passage through which the combustion gas generated by the warm-up burner flows so as to allow heat exchange between the oxidant gas flowing through the stack temperature controller and the combustion gas generated by the warm-up burner.

### BRIEF DESCRIPTION OF THE DRAWINGS

FIG. 1 is a schematic configuration diagram of a fuel cell system including a fuel cell module according to a first embodiment;

FIG. 2 is an explanatory diagram for explaining an electrochemical reaction inside a fuel cell;

FIG. 3 is a schematic perspective view of a cell stack of the first embodiment;

FIG. 4 is a schematic vertical cross-sectional view showing the arrangement of cell stacks in a battery container;

FIG. 5 is a schematic lateral cross-sectional view showing the arrangement of cell stacks in the battery container;

FIG. 6 is a block diagram showing an electronic control unit of the fuel cell system;

FIG. 7 is a flow chart showing a flow of control processing executed by the electronic control unit of the fuel cell system;

FIG. 8 is an explanatory diagram for explaining a state of a fuel cell module during an initial warm-up process;

FIG. 9 is an explanatory diagram for explaining a state of the fuel cell module during a warm-up promotion process;

FIG. 10 is an explanatory diagram for explaining a state of the fuel cell module during a power generation process;

FIG. 11 is an explanatory diagram for explaining a temperature adjustment of the cell stack during a power generation;

FIG. 12 is a schematic vertical sectional view showing a part of a fuel cell module according to a second embodiment;

FIG. 13 is a schematic vertical sectional view showing a part of a fuel cell module according to a third embodiment;

FIG. 14 is a schematic vertical sectional view showing a part of a fuel cell module according to a fourth embodiment;

FIG. 15 is a schematic vertical sectional view showing a part of a fuel cell module according to a fifth embodiment;

FIG. 16 is a schematic configuration diagram of a fuel cell system including a fuel cell module according to a sixth embodiment;

FIG. 17 is a schematic vertical sectional view showing a part of the fuel cell module of the sixth embodiment;

FIG. 18 is a schematic configuration diagram of a fuel cell system including a fuel cell module according to a seventh embodiment; and

FIG. 19 is a schematic vertical sectional view showing a part of the fuel cell module of the seventh embodiment.

### DETAILED DESCRIPTION

To begin with, examples of relevant techniques will be described. There is known a fuel cell module in which a starting burner is arranged inside a fuel cell including a stack of fuel cells (that is, a cell stack). The fuel cell can be efficiently heated by heat radiation and conduction from the starting burner, in a compact configuration, by arranging the starting burner in the vicinity of the cell stack.

In the above example, the starting burner is arranged near the oxidant gas inlet of the cell stack in the interior of the fuel cell, and high-temperature combustion gas immediately after being generated by the starting burner is supplied into the cell stack (specifically, the flow path for the oxidant gas). In such a structure, the inside of the cell stack is heated by the extremely high temperature combustion gas, while the outside (that is, the outer surface side) of the cell stack is heated by the starting burner only near the oxidant gas inlet of the cell stack. For this reason, in the prior art, the temperature distribution between the inside and the outside of the cell stack expands. If the temperature distribution between the inside and the outside of the cell stack expands, the thermal stress generated in the cell stack may damage the cell stack, which is not preferable. The present disclosure provides a fuel cell module capable of heating a cell stack while suppressing increase in temperature distribution between the inside and the outside of the cell stack.

According to an aspect of the present disclosure, a fuel cell module includes: a cell stack in which a plurality of fuel cells are stacked so as to output electrical energy through an electrochemical reaction between a fuel gas and an oxidant gas; a stack temperature controller through which the oxidant gas before being supplied to the cell stack flows; and a warm-up burner configured to generate combustion gas to warm up the cell stack. The warm-up burner is arranged outside a housing space in which the cell stack is arranged. The stack temperature controller is arranged to face the cell stack with a predetermined gap therebetween so as to allow heat exchange with the cell stack, and is located adjacent to a combustion gas passage through which the combustion gas generated by the warm-up burner flows so as to allow heat exchange between the oxidant gas flowing through the stack temperature controller and the combustion gas generated by the warm-up burner.

In this way, since the warm-up burner is arranged outside the housing space for the cell stack, the heat generated by the warm-up burner is suppressed from being directly transmitted to the cell stack, compared to a case where the warm-up burner is arranged inside the housing space for the cell stack. Further, the stack temperature controller is disposed facing the cell stack and adjacent to the combustion gas passage. Accordingly, when the fuel cell is started or when the temperature is low, the outside of the cell stack is heated by radiant heat transfer from the stack temperature controller, and the oxidant gas whose temperature is raised by the stack temperature controller is introduced into the cell stack. Thus, the inside of the cell stack can be heated. In particular, by arranging the stack temperature controller facing the cell stack at a predetermined interval, the temperature outside the cell stack can be suppressed from being locally overheated, compared to a case where the high-temperature warm-up burner is arranged close to the cell stack. In addition, by introducing the oxidant gas heated by the stack temperature controller into the cell stack, the inside of the cell stack can be suppressed from being excessively heated, compared to a case where the high-temperature combustion gas is introduced into the cell stack.

Therefore, according to the fuel cell module of the present disclosure, the cell stack can be heated while suppressing increase in the temperature distribution between the inside and the outside of the cell stack. As a result, it is possible to improve the startability of the fuel cell while ensuring the reliability of the cell stack.

The reference numerals in parentheses attached to the components and the like indicate an example of correspondence between the components and the like and specific components and the like described in embodiments to be described below.

Hereinafter, embodiments of the present disclosure will be described with reference to the drawings. In the following embodiments, portions that are the same as or equivalent to those described in the preceding embodiments are denoted by the same reference numerals, and a description of the same or equivalent portions may be omitted. In addition, when only a part of the components is described in the embodiment, the components described in the preceding embodiment can be applied to other parts of the components. The following embodiments may be partially combined with each other even if such a combination is not explicitly described as long as there is no disadvantage with respect to such a combination.

### First Embodiment

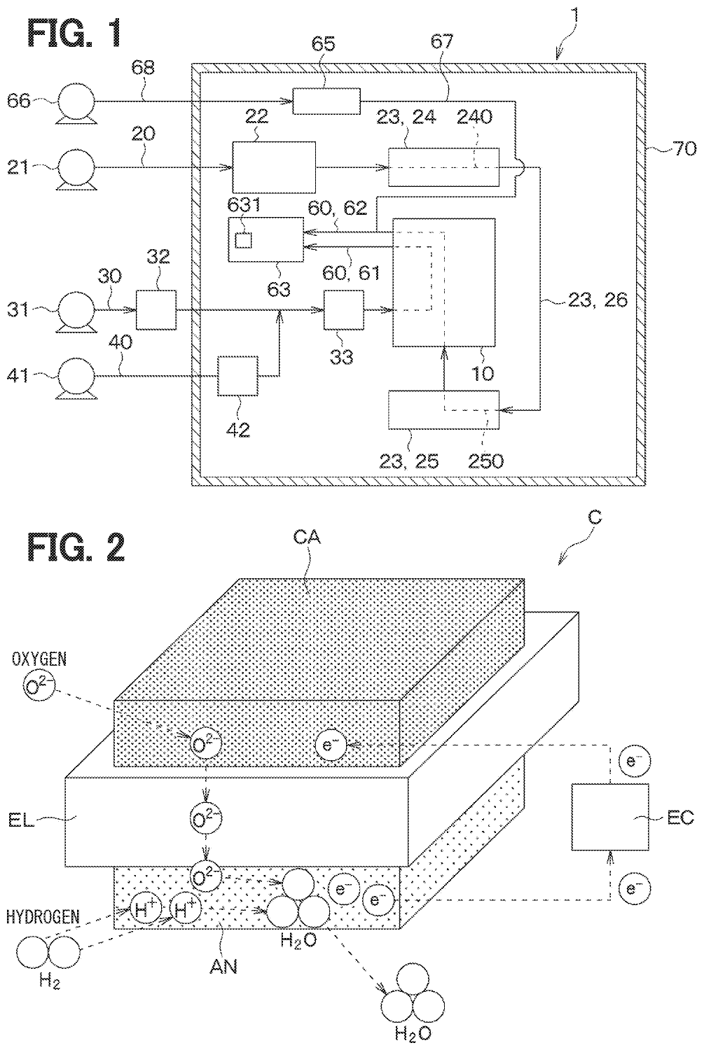

The present embodiment will be described with reference to FIGS. 1 to 11. In the present embodiment, as shown in FIG. 1, a fuel cell module 1 is applied to a fuel cell system including a solid-oxide-type fuel cell 10.

The fuel cell module 1 is a hot module that includes a fuel processing system and a battery system, and keeps both of the systems at a high temperature by covering them with a heat insulating material. The fuel cell module 1 includes an air preheater 22, a water evaporator 42, a reformer 33, an off-gas combustor 63, a container 70 in addition to the fuel cell 10.

The fuel cell 10 is also generally called SOFC (abbreviation for Solid Oxide Fuel Cell) and its operating temperature is high (for example, 500° C. to 1000° C.). The fuel cell 10 has plural fuel cells C that output electrical energy through an electrochemical reaction between a fuel gas and an oxidant gas (oxygen in air in this embodiment). The fuel cell C will be simply referred to as the cell C hereinafter.

As shown in FIG. 2, the cell C includes an electrolyte body EL, an air electrode (that is, cathode) CA, a fuel electrode (that is, anode) AN, and a separator (not shown) that forms air channels and fuel channels. The cell C uses hydrogen and carbon monoxide as fuel gas. This fuel gas is produced by reforming city gas (that is, a gas containing methane as a main component), which is a raw material for reforming. The raw material to be used may be a hydrocarbon-based gas other than city gas, or a gas that generates hydrogen by reforming, such as ammonia. The raw material may be a mixed gas in which hydrogen is mixed with a hydrocarbon-based gas or ammonia.

The cell C outputs electric energy to an external circuit EC by the electrochemical reaction of hydrogen and oxygen shown in the following reaction formulas F1 and F2.

(Fuel electrode) 2H₂+2O²⁻→2H₂O+4e⁻ (F1)

(Air electrode) O₂+4e⁻→2O²⁻ (F2)

Further, the cell C outputs electric energy to the external circuit EC by the electrochemical reaction of carbon monoxide and oxygen shown in the following reaction formulas F3 and F4.

(Fuel electrode) 2CO+2O²⁻→2CO₂+4e⁻ (F3)

(Air electrode) O₂+4e⁻→2O²⁻ (F4)

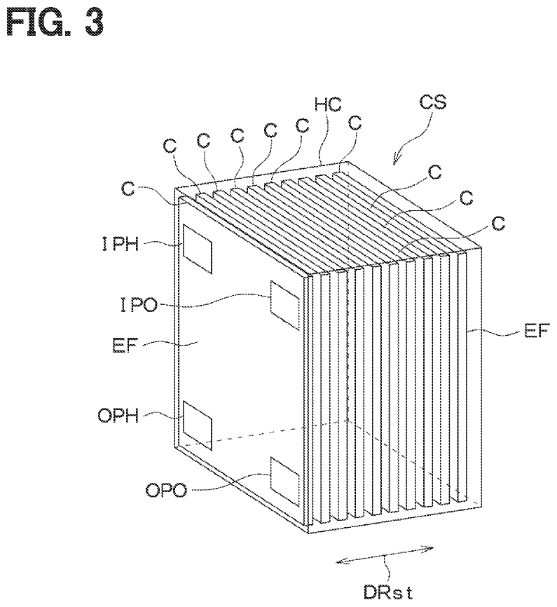

The fuel cell 10 has plural cell stacks CS in which a predetermined number of cells C are stacked. As shown in FIG. 3, in the cell stack CS, the flat plate type cells C are stacked in a predetermined stacking direction DRst. The predetermined number of cells C constituting the cell stack CS are electrically connected in series. The cell stack CS is a laminate in which the predetermined number of cells C are stacked in a row. The cell stack CS is held by a holder case HC. The holder case HC is a case that houses the cell stack CS.

The cell stack CS has a laminated end surface EF at an end of the cell C in the stacking direction DRst. The laminated end surface EF has an introduction port IPH for the fuel gas, an introduction port IPO for the oxidant gas, an outlet OPH for the fuel gas, and an outlet OPO for the oxidant gas. In the present embodiment, the introduction port IPH and the introduction port IPO correspond to a fuel gas inlet and an oxidant gas inlet respectively.

The fuel cell 10 configured in this way is arranged inside the container 70 having heat insulating properties together with the air preheater 22, the reformer 33, the water evaporator 42, the off-gas combustor 63, and the like. The arrangement of the fuel cell 10 inside the container 70 will be described later.

As shown in FIG. 1, the fuel cell 10 is connected to an air path 20 which is an air distribution path. The air path 20 is composed of pipes and the like. The air path 20 is provided with a pressure feed blower 21 for pressure-feeding air to the fuel cell 10, the air preheater 22 for heating the air supplied to the fuel cell 10, and a stack temperature controller 23.

The pressure feed blower 21 is an oxidant pump that sucks air in the atmosphere and supplies it to the fuel cell 10. The pressure feed blower 21 is an electric blower whose operation is controlled by a control signal from an electronic control unit 100, which will be described later.

The air preheater 22 is a heat exchanger that exchanges heat of the combustion gas generated in the off-gas combustor 63 to heat the air that is pressure-fed from the pressure feed blower 21 when the fuel cell 10 generates power. The air preheater 22 is provided to reduce the temperature difference between the air supplied to the fuel cell 10 and the fuel gas, thereby improving the power generation efficiency of the fuel cell 10.

The stack temperature controller 23 is connected between the air preheater 22 and the fuel cell 10 so that the air that has passed through the air preheater 22 flows. As a result, the oxidant gas before being supplied to the cell stack CS flows through the stack temperature controller 23.

The stack temperature controller 23 is arranged facing the cell stack CS with a predetermined gap therebetween so as to be able to exchange heat with the cell stack CS of the fuel cell 10. The stack temperature controller 23 and the cell stack CS are arranged to transfer heat from the stack temperature controller 23 to the cell stack CS when the fuel cell 10 is started. In addition, the stack temperature controller 23 and the cell stack CS are arranged to conduct heat of the cell stack CS to the stack temperature controller 23 when the fuel cell 10 generates power.

The stack temperature controller 23 is provided adjacent to a combustion gas passage 67 through which the combustion gas produced at a warm-up burner 65 (to be described later) flows. Thus, when the fuel cell 10 is started, the oxidant gas flowing through the stack temperature controller 23 can exchange heat with the combustion gas generated by the warm-up burner 65.

Specifically, the stack temperature controller 23 includes a first temperature controller 24 adjacent to the combustion gas passage 67 and a second temperature controller 25 into which the oxidant gas that has passed through the first temperature controller 24 flows, and a connection passage 26 that connects the first temperature controller 24 and the second temperature controller 25. The first temperature controller 24, the second temperature controller 25, and the connection passage 26 are configured integrally with a battery container 71, which will be described later.

The first temperature controller 24 has a first temperature control passage 240 into which the air that has passed through the air preheater 22 flows. The first temperature controller 24 is arranged between the combustion gas passage 67 and the cell stack CS of the fuel cell 10. The first temperature controller 24 receives heat from the combustion gas flowing through the combustion gas passage 67 when the fuel cell 10 is started, and is heated together with the air flowing through the first temperature control passage 240. When the fuel cell 10 is started, the heat of the first temperature controller 24 is radiated to the cell stack CS. In addition, the first temperature controller 24 adjusts the temperature of the cell stack CS by absorbing heat from the cell stack CS, which is heated due to self-heating caused by the power generation, during the power generation of the fuel cell 10.

The second temperature controller 25 has a second temperature control passage 250 into which the air that has passed through the first temperature controller 24 flows via the connection passage 26. The second temperature controller 25 is arranged on the opposite side of the first temperature controller 24 across the cell stack CS of the fuel cell 10. Air heated by the first temperature controller 24 flows through the second temperature controller 25 when the fuel cell 10 is started. When the fuel cell 10 is started, the heat of the second temperature controller 25 is radiated to the cell stack CS. In addition, the second temperature controller 25 adjusts the temperature of the cell stack CS by absorbing heat from the cell stack CS, which is heated due to self-heating caused by the power generation, during the power generation of the fuel cell 10.

Further, the fuel cell 10 is connected to a fuel path 30 which is a distribution channel for the raw material for reforming and the fuel gas. The fuel path 30 is composed of pipes and the like. A fuel pump 31, a desulfurizer 32, and a reformer 33 are provided in the fuel path 30 in this order from an upstream side.

The fuel pump 31 supplies the raw material toward the fuel cell 10. The fuel pump 31 is an electric pump whose operation is controlled by a control signal from the electronic control unit 100, which will be described later.

The desulfurizer 32 removes a sulfur component contained in the reforming raw material supplied from the fuel pump 31. The city gas contains an odorant (specifically, a sulfur component). Since the sulfur component is a catalyst poisoning substance, it is necessary to remove it upstream of the reformer 33.

The reformer 33 reforms the reforming raw material supplied from the fuel pump 31 by using steam to generate fuel gas. The reformer 33 is configured to include, for example, a steam reforming catalyst containing a precious metal such as rhodium or ruthenium.

Specifically, the reformer 33 heats the mixed gas, which is a mixture of the reforming raw material and steam, by exchanging heat with the combustion gas. The reformer 33 produces the fuel gas (hydrogen, carbon monoxide) by a reforming reaction shown in a following reaction formula F5 and a shift reaction shown in a following reaction formula F6.

CH₄+H₂O→CO+3H₂ (F5)

CO+H₂O→CO₂+H₂ (F6)

Here, the steam reforming in the reformer 33 is an endothermic reaction, and has characteristic that the reforming rate is improved under high temperature conditions. Therefore, the reformer 33 is preferably arranged around the fuel cell 10 so as to absorb the radiant heat emitted from the cell stack CS to the surroundings when the fuel cell 10 generates power.

The water supply path 40 is connected to the fuel path 30 between the fuel pump 31 and the reformer 33. The water supply path 40 is provided with the water pump 41 and the water evaporator 42. The water pump 41 supplies water to the water evaporator 42. The water pump 41 is an electric pump whose operation is controlled by a control signal from the electronic control unit 100, which will be described later. The water evaporator 42 has an evaporation function of converting water from the water pump 41 into steam (that is, a gas).

Further, the fuel cell 10 is connected to the off-gas path 60 through which the off gas discharged from the fuel cell 10 flows. Specifically, the fuel cell 10 is connected to an air discharge path 61 through which the oxidant off gas discharged from the fuel cell 10 flows, and a fuel discharge path 62 through which the fuel off gas discharged from the fuel cell 10 flows.

An off-gas combustor 63 is connected to the off-gas path 60. The off-gas combustor 63 burns the fuel off-gas and the like to generate combustion gas that raises the temperature of the reformer 33 and the like. For example, when the fuel cell 10 generates power, the off-gas combustor 63 generates the combustion gas for raising the temperature of each device of the fuel cell system by burning a mixed gas in which the oxidant off gas and the fuel off gas are mixed as a combustible gas. The off-gas combustor 63 has an off-gas burner 631 for burning the fuel off-gas. In the off-gas combustor 63, ignition of the off-gas burner 631 starts combustion of the fuel off-gas to generate the combustion gas.

The off-gas combustor 63 is connected to an external exhaust passage (not shown) through which high-temperature combustion gas flows. Although not shown, the external exhaust passage is thermally connected to the reformer 33, the air preheater 22, the water evaporator 42, etc. in order to effectively utilize the heat of the combustion gas flowing inside. The order in which the heat of the combustion gas is transferred may be changed according to the amount of heat required by each device.

Although not shown, the fuel discharge path 62 of the off-gas path 60 is connected to a circulation path for returning the fuel gas that has passed through the fuel cell 10 to the upstream of the fuel cell 10. As a result, the fuel gas that has passed through the fuel cell 10, when the fuel cell 10 is started, is returned to the upstream of the fuel cell 10 via the circulation path.

The fuel cell module 1 has the warm-up burner 65 that generates combustion gas for warming up the cell stack CS when the fuel cell 10 is started. The warm-up burner 65 burns a mixed gas of a part of the reforming raw material flowing through the fuel path 30 and air blown from the start-up blower 66 provided separately from the pressure feed blower 21 as a combustible gas. High temperature combustion gas generated by combustion of the combustible gas is supplied to the combustion gas passage 67. The combustion gas passage 67 is connected to a blown air flow path 68 for air blown from the start-up blower 66. As a result, not only the combustible gas but also a part of the air blown from the start-up blower 66 is introduced into the combustion gas passage 67.

The fuel cell 10, the air preheater 22, the reformer 33, the water evaporator 42, the off-gas combustor 63, and the warm-up burner 65 are arranged inside the container 70 having heat insulating properties. The container 70 forms an outer shell of the fuel cell module 1. Although not shown, the air preheater 22, the reformer 33, and the water evaporator 42 are positioned inside the container 70 around the off-gas combustor 63 to receive heat from the off-gas combustor 63 and the warm-up burner 65. The fuel cell 10 is placed in a thermally insulated space different from the space housing the air preheater 22, the reformer 33, the water evaporator 42, and the off-gas combustor 63, not to directly receive the heat of the off-gas combustor 63.

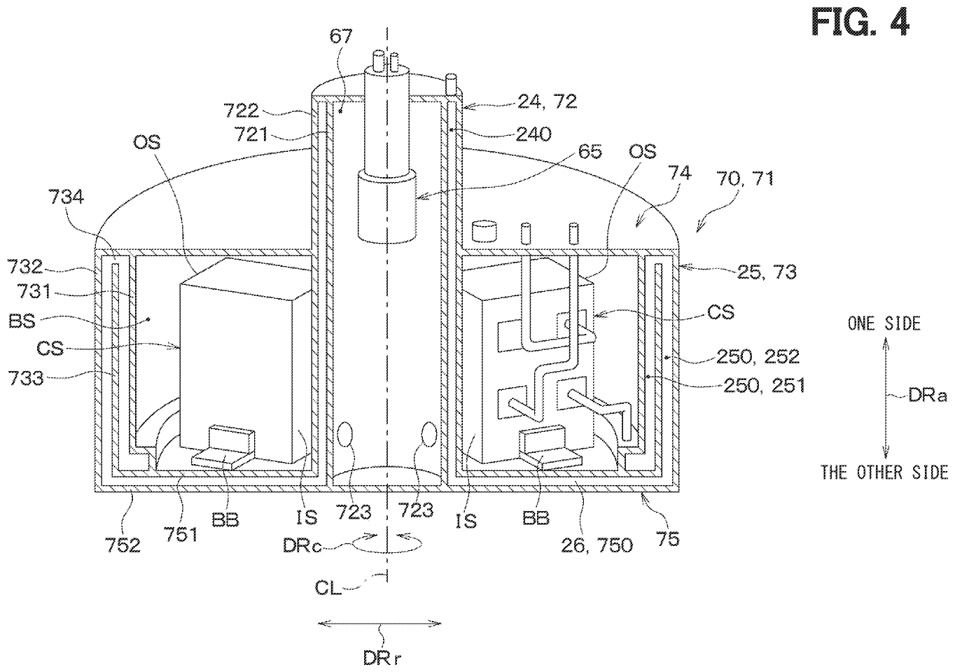

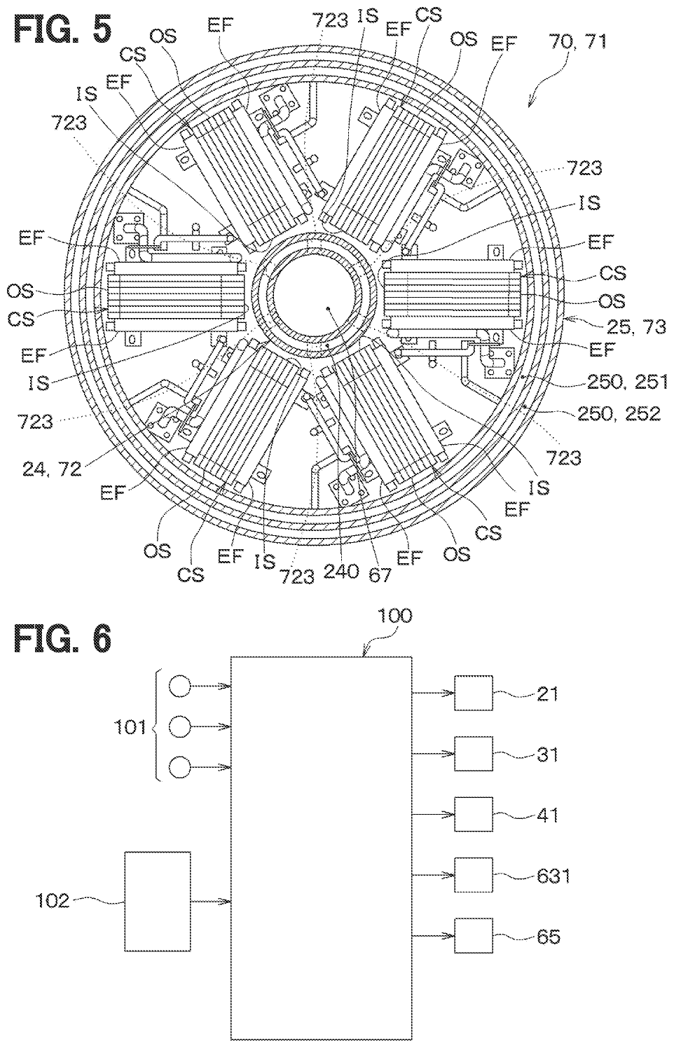

As shown in FIGS. 4 and 5, the container 70 has the battery container 71 for housing the fuel cell 10. The battery container 71 has a double-cylinder structure, and a doughnut-shaped space is formed inside. This space constitutes the housing space BS in which the cell stack CS is arranged. The battery container 71 is arranged in such a posture that an axial center CL of the battery container 71 extends along a direction in which gravity acts (that is, a vertical direction).

In the present embodiment, a direction extending along the axial center CL of the battery container 71 is defined as an axial direction DRa, a direction passing through the axial center CL of the battery container 71 and orthogonal to the axial direction DRa is defined as a radial direction DRr, and a direction along a circle centered on the axial center CL of the battery container 71 is defined as a circumferential direction DRc.

In the storage space BS inside the battery container 71, the cell stacks CS are radially arranged around the axial center CL of the battery container 71. In other words, the cell stacks CS are arranged at regular intervals in the circumferential direction DRc in the housing space BS. The intervals between the cell stacks CS in the circumferential direction DRc do not have to be the same, and some of them may be different from others.

The cell stacks CS adjacent to each other in the circumferential direction DRc are arranged in such a posture that the laminated end surfaces EF face each other. In other words, the laminated end surfaces EF of the cell stacks CS adjacent to each other in the circumferential direction DRc face each other in the circumferential DRc with a predetermined interval. Further, one side surface of the cell stack CS extending along the stacking direction DRst faces the inner side of the battery container 71 as an inner side surface IS, and the other side surface of the cell stack CS faces the outer side of the battery container 71 as an outer side surface OS. The inner side surface IS of the cell stack CS constitutes an inner portion of the cell stack CS when the cell stacks CS are radially arranged inside the container 70. Further, the outer side surface OS of the cell stack CS constitutes an outer portion of the cell stack CS when the cell stacks CS are radially arranged inside the container 70.

As shown in FIG. 4, the battery container 71 of this embodiment includes an inner cylinder 72, an outer cylinder 73 positioned outside the inner cylinder 72, an upper lid 74 covering the top of the outer cylinder 73, and a base plate 75 that connects a bottom of the inner cylinder 72 and a bottom of the outer cylinder 73.

The inner cylinder 72 is positioned inside the cell stacks CS in the battery container 71. A part of the inner cylinder 72 protrudes above the upper lid 74. The outer cylinder 73 is positioned outside the cell stacks CS in the battery container 71. The housing space BS is defined by the inner cylinder 72, the outer cylinder 73, the upper lid 74 and the base plate 75. The inner cylinder 72 and the outer cylinder 73 are each formed in a cylindrical shape. The inner cylinder 72 and the outer cylinder 73 are coaxially arranged.

The inner cylinder 72 constitutes the first temperature controller 24 of the stack temperature controller 23. The inner cylinder 72 is arranged to face the cell stack CS with a predetermined gap therebetween so as to be able to exchange heat with the cell stack CS. The inner cylinder 72 faces the inner side surface IS of the cell stack CS with a predetermined gap therebetween so as to receive radiant heat from the cell stack CS when the fuel cell 10 generates power. A dimension of the inner cylinder 72 in the axial direction DRa is larger than the dimension of the cell stack CS in the axial direction DRa so that the inner cylinder 72 can cover the entire inner side surface IS of the cell stack CS.

Further, the inner cylinder 72 has a double wall structure having a first inner wall 721 and a first outer wall 722 so that a fluid can pass therethrough. The first inner wall 721 and the first outer wall 722 are each composed of a cylindrical body. The first inner wall 721 and the first outer wall 722 are coaxially arranged. A space defining portion such as a spacer or a dowel is provided between the first inner wall 721 and the first outer wall 722, and a substantially constant gap is formed by the space defining portion. Air that exchanges heat with the inner side surface IS of the cell stack CS is introduced into a clearance flow path formed between the first inner wall 721 and the first outer wall 722. In this embodiment, the clearance flow path formed in the inner cylinder 72 constitutes a first temperature control passage 240. Below, the clearance channel formed in the inner cylinder 72 is referred to as a first temperature control passage 240.

Inside the first inner wall 721, the warm-up burner 65 is arranged on one side in the axial direction DRa, and the combustion gas passage 67 is formed on the other side of the warm-up burner 65 in the axial direction DRa. That is, the inner cylinder 72 as the first temperature controller 24 is provided adjacent to the combustion gas passage 67 so as to allow heat exchange between the combustion gas and the oxidant gas. The inner cylinder 72 is arranged between the combustion gas passage 67 and the cell stack CS.

A gas introduction hole 723 is formed in the inner cylinder 72 for guiding the combustion gas flowing through the combustion gas passage 67 to the housing space BS of the cell stack CS. The combustion gas flowing through the combustion gas passage 67 is introduced into the housing space BS through the gas introduction hole 723.

The opening position of the gas introduction hole 723 adjacent to the housing space BS is set so that the high-temperature combustion gas is not blown to a local portion of the cell stack CS. That is, the opening of the gas introduction hole 723 adjacent to the housing space BS is formed at a portion of the inner cylinder 72 not to face the cell stack CS in the arrangement direction in which the inner cylinder 72 and the cell stack CS are arranged (that is, in the radial direction DRr). The opening of the gas introduction hole 723 adjacent to the combustion gas passage 67 is formed at a portion of the inner cylinder 72 that does not face the cell stack CS. Specifically, as shown in FIG. 5, the gas introduction hole 723 is formed at a position corresponding to the gap between the adjacent cell stacks CS in the inner cylinder 72 so that the combustion gas is introduced into the gap between the adjacent cell stacks CS.

The outer cylinder 73 constitutes the second temperature controller 25 of the stack temperature controller 23. The outer cylinder 73 is arranged facing the cell stack CS with a predetermined gap therebetween so as to be able to exchange heat with the cell stack CS. The outer cylinder 73 faces the outer side surface OS of the cell stack CS with a predetermined gap therebetween so as to receive radiant heat from the cell stack CS when the fuel cell 10 generates power. A dimension of the outer cylinder 73 in the axial direction DRa is larger than the dimension of the cell stack CS in the axial direction DRa so that the inner cylinder 72 can cover the entire outer side surface OS of the cell stack CS.

The outer cylinder 73 has a double wall structure having a second inner wall 731 and a second outer wall 732 so that a fluid can pass therethrough. The second inner wall 731 and the second outer wall 732 are each configured as a cylindrical body.

The second inner wall 731 and the second outer wall 732 are coaxially arranged. A space defining portion such as a spacer or a dowel is provided between the second inner wall 731 and the second outer wall 732, and a substantially constant gap is formed by the space defining portion. Air that exchanges heat with the outer side surface OS of the cell stack CS is introduced into a clearance flow path formed between the second inner wall 731 and the second outer wall 732. In this embodiment, the clearance flow path formed in the outer cylinder 73 constitutes the second temperature control passage 250. Below, the clearance flow path formed in the outer cylinder 73 is called as the second temperature control passage 250.

The second temperature control passage 250 of this embodiment has an inner flow path portion 251 closer to the cell stack CS and an outer flow path portion 252 farther from the cell stack CS than the inner flow path portion 251. The second temperature control passage 250 has a flow path structure in which the air that has passed through the outer flow path portion 252 is turned back and flows into the inner flow path portion 251.

Specifically, a separation plate 733 is provided inside the outer cylinder 73 to divide the second temperature control passage 250 into the inner flow path portion 251 and the outer flow path portion 252. The inner flow path portion 251 and the outer flow path portion 252 each extend along the axial direction DRa. One side of the outer flow path portion 252 in the axial direction DRa communicates with the inner flow path portion 251 via a folded portion 734, and the other side of the outer flow path portion 252 in the axial direction DRa communicates with the communication passage 740. One side of the inner flow path portion 251 in the axial direction DRa communicates with the outer flow path portion 252 via the folded portion 734, and the other side of the inner flow path portion 251 in the axial direction DRa is connected to the cell stack CS via a pipe or the like (not shown). In the second temperature control passage 250, the flow path cross-sectional area of the inner flow path portion 251 is larger than or equal to the flow path cross-sectional area of the first temperature control passage 240.

The second temperature control passage 250 has a larger heat transfer area that receives heat from the cell stack CS than the first temperature control passage 240 has. In this case, the temperature difference between the upstream and the downstream of the second temperature control passage 250 becomes large, and there is a possibility that the temperature of the second temperature control passage 250 becomes non-uniform.

Since the second temperature control passage 250 has a flow path structure in which air is turned back and flows, the flows of air face each other between the inner flow path portion 251 and the outer flow path portion 252 of the second temperature control passage 250. Therefore, the temperature in the inner flow path portion 251 near the outer portion of the cell stack CS is made uniform. As a result, temperature unevenness in the outer portion of the cell stack CS is suppressed.

The upper lid 74 covers the upper portion of the outer cylinder 73 and has a doughnut-like shape so that a part of the inner cylinder 72 can protrude outward. A pipe for supplying the fuel gas to the cell stack CS, a pipe forming the air discharge path 61, a pipe forming the fuel discharge path 62, and the like pass through the upper lid 74.

The base plate 75 connects the bottom of the inner cylinder 72 and the bottom of the outer cylinder 73, and has a disk-like shape. The base plate 75 supports the cell stacks CS via a bus bar BB and the like. The base plate 75 faces a lower surface of the cell stack CS. The base plate 75 has a size capable of covering the entire lower surface of the cell stack CS.

The base plate 75 has a double wall structure having an upper wall 751 and a lower wall 752 so that a fluid can pass therethrough. A space defining portion such as a spacer or a dowel is provided between the upper wall 751 and the lower wall 752, and a substantially constant gap is formed by the space defining portion.

In the base plate 75, the upper wall 751 is connected to the first outer wall 722 of the inner cylinder 72 and the second inner wall 731 of the outer cylinder 73, and the lower wall 752 is connected to the first inner wall 721 of the inner cylinder 72 and the second outer wall 732 of the outer cylinder 73. The communication passage 750 is formed between the upper wall 751 and the lower wall 752 to communicate the clearance flow path of the inner cylinder 72 and the clearance flow path of the outer cylinder 73. The communication passage 750 corresponds to the connection passage 26 described above.

The inner cylinder 72 has a larger curvature than the outer cylinder 73, and an area of a portion facing the cell stack CS is small. Therefore, the heat transfer area of the inner cylinder 72 with respect to the cell stack CS is smaller than that of the outer cylinder 73 with respect to the cell stack CS. In the battery container 71, if the heat transfer area is different between the inside and the outside, the amount of heat transfer due to convection is smaller on the inner side than on the outer side of the cell stack CS when a fluid having the same temperature and the same flow velocity flows through the clearance flow path formed in the inner cylinder 72 and the clearance flow path formed in the outer cylinder 73. This difference in the amount of heat transfer causes the temperature distribution between the inner portion and the outer portion of the cell stack CS to expand. Such an expansion of the temperature distribution is not preferable because it causes a decrease in power generation efficiency and a decrease in durability.

In consideration of these factors, the battery container 71 is designed so that the fluid flowing through the first temperature control passage 240 formed in the inner cylinder 72 is more likely to have a temperature difference relative to the cell stack CS larger than that of the fluid flowing through the second temperature control passage 250 formed in the outer cylinder 73. For example, when the temperature of the cell stack CS is low and it is necessary to warm up the cell stack CS, the temperature of fluid flowing through the first temperature control passage 240 is higher than or equal to that of the fluid flowing through the second temperature control passage 250. Further, when the cell stack CS needs to be cooled or kept warm, the temperature of fluid flowing through the first temperature control passage 240 is lower than that of the fluid flowing through the second temperature control passage 250. It is necessary to cool or keep the cell stack CS warm, mainly during power generation by the fuel cell 10.

Specifically, when the fuel cell 10 is activated, air whose temperature has been raised by the combustion gas flows through the first temperature control passage 240, and the air that has emitted heat to the cell stack CS when passing through the first temperature control passage 240 and the connection passage 26 flows through the second temperature control passage 250. Further, when the fuel cell 10 generates electric power, the air whose temperature has been raised by the air preheater 22 flows through the first temperature control passage 240, and the air that has received heat from the cell stack CS when passing through the first temperature control passage 240 and the connection passage 26 flows through the second temperature control passage 250. In the inner cylinder 72 and the outer cylinder 73 of the present embodiment, a distance between the first inner wall 721 and the first outer wall 722 and a distance between the second inner wall 731 and the second outer wall 732 are substantially the same. The inner cylinder 72 has a smaller radius of curvature than the outer cylinder 73. Therefore, the cross-sectional area of the first temperature control passage 240 is smaller than the cross-sectional area of the second temperature control passage 250. According to the law of continuity, when a steady-state fluid flows through a non-branched flow path, the mass flow rates in any cross section of the flow path are equal. In the battery container 71 of the present embodiment, the first temperature control passage 240 and the second temperature control passage 250 are connected in series, and the flow path cross-sectional area of the first temperature control passage 240 is smaller than the flow path cross-sectional area of the temperature control passage 250. Therefore, the flow speed of air in the first temperature control passage 240 is higher than that of the air flowing through the second temperature control passage 250.

Next, the electronic control unit 100 of the fuel cell system will be described with reference to FIG. 6. The electronic control unit 100 is composed of a microcomputer including a processor and memory, and its peripheral circuits. The electronic control unit 100 performs various calculations and processes based on a control program stored in the memory, and controls the operation of various control devices connected to an output side.

A sensor group 101 including a battery temperature sensor, a reforming temperature sensor, and a flame detector is connected to the input side of the electronic control unit 100, and the detection results of the sensor group 101 are input to the electronic control unit 100. An operation panel 102 and a DC-DC converter (not shown) are connected to the electronic control unit 100. The operation panel 102 has a start switch for turning the power generation of the fuel cell 10 on and off, and a display for displaying the operating state of the fuel cell 10. The DC-DC converter is a current sweeping device for controlling the battery sweeping from the cell C.

On the output side of the electronic control unit 100, the pressure feed blower 21, the fuel pump 31, the water pump 41, the off-gas burner 631, the warm-up burner 65, etc. are connected as control devices. The operations of the control devices are controlled according to control signals output from the electronic control unit 100.

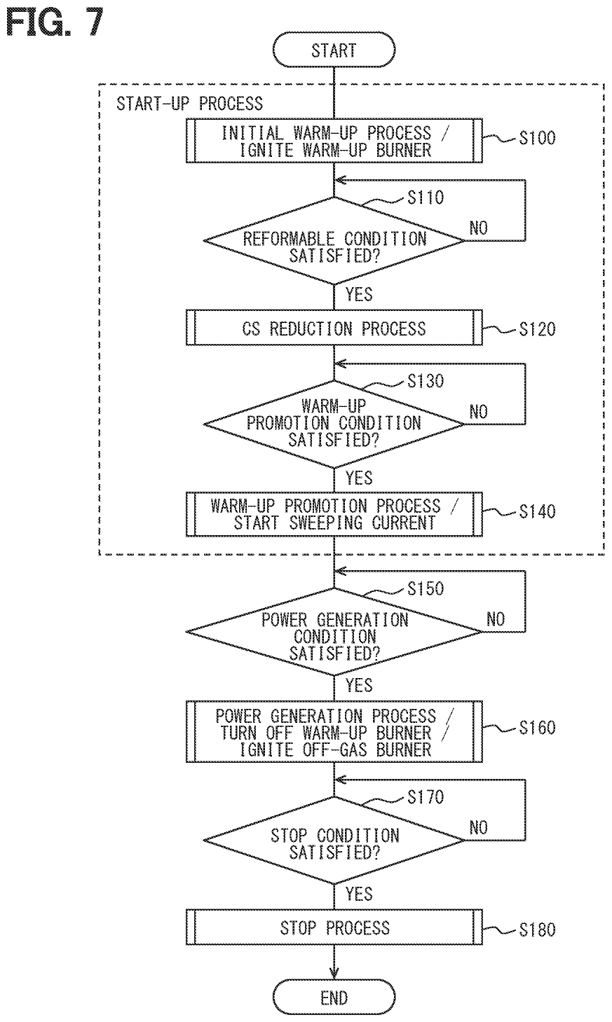

Next, the overall operation of the fuel cell system will be described with reference to the flow chart of FIG. 7. Each control process shown in FIG. 7 is executed by the electronic control unit 100 when the start switch is turned on.

When the start switch is turned on, as shown in FIG. 7, the electronic control unit 100 executes the start-up process of the cell C including the initial warm-up process, the CS reduction process, and the warm-up promotion process. Specifically, the electronic control unit 100 executes the initial warm-up process in step S100.

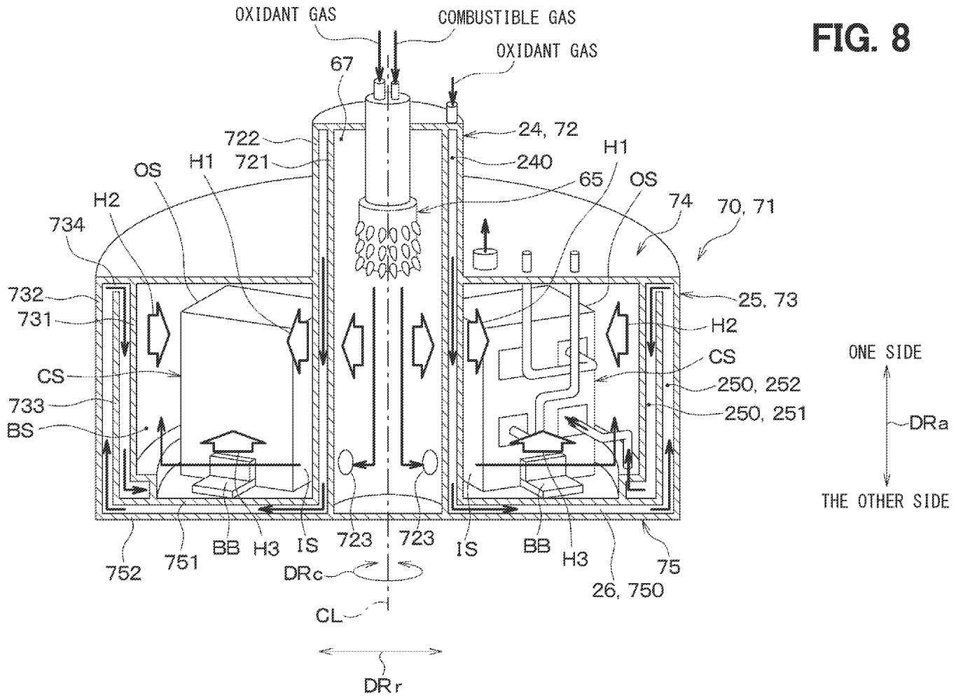

The initial warm-up process is for raising the temperature of various devices including the cell stack CS to an appropriate temperature. During the initial warm-up process, the electronic control unit 100 operates the pressure feed blower 21 and ignites the warm-up burner 65 while supplying fuel and air to the combustion gas passage 67. When the warm-up burner 65 is ignited, as shown in FIG. 8, a mixed gas of fuel and air is combusted as combustible gas to generate high-temperature combustion gas.

In the stack temperature controller 23 of this embodiment, the first temperature controller 24 is provided adjacent to the combustion gas passage 67. Therefore, the combustion gas flowing through the combustion gas passage 67 raises the temperatures of the first temperature controller 24 and the air flowing through the first temperature control passage 240. The air whose temperature has been raised by the first temperature controller 24 flows to the second temperature controller 25 via the connection passage 26, and then is supplied to the cell stack CS. As a result, during the initial warm-up process, the outside of the cell stack CS is heated by the radiant heat transfer H1, H2 from the stack temperature controller 23, and the air heated by the stack temperature controller 23 is introduced into the cell stack CS. As a result, the inside of the cell stack CS is heated.

The high-temperature combustion gas flowing through the combustion gas passage 67 is introduced into the housing space BS via the gas introduction hole 723. Then, the outside of the cell stack CS is heated by the convective heat transfer H3 caused by the combustion gas introduced into the housing space BS. The combustion gas introduced into the housing space BS is exhausted through the air discharge path 61 of the off-gas path 60. The combustion gas releases heat to the reformer 33, the air preheater 22 and the water evaporator 42 when flowing through the off-gas path 60. Thereby, the reformer 33, the air preheater 22, and the water evaporator 42 are heated.

After starting the initial warm-up process, the electronic control unit 100 determines in step S110 whether or not the reformable condition is satisfied. The reformable condition determines whether or not the reformer 33 can start generating fuel gas. The reformable condition is satisfied, for example, when the water evaporator 42 reaches a temperature (for example, 100° C.) at which the water evaporator 42 can generate steam and the reformer 33 reaches a temperature (for example, 300° C.) at which the reformer 33 can generate fuel gas. The electronic control unit 100 continues the initial warm-up process until the reformable condition is satisfied, and executes the CS reduction process in step S120 when the reformable condition is satisfied.

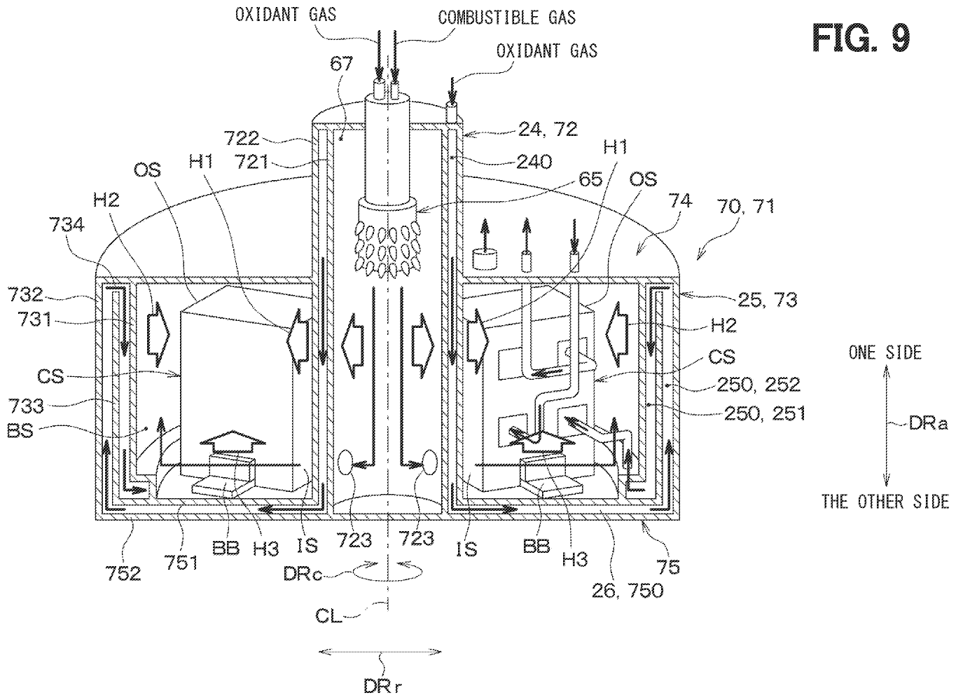

The CS reduction process is for suppressing oxidation of the cell stack CS due to temperature rise of the cell stack CS. During the CS reduction process, the electronic control unit 100 controls the water pump 41 so that water is supplied to the water evaporator 42, and controls the fuel pump 31 so that fuel is supplied to the reformer 33 as shown in FIG. 9. Fuel and steam are thereby supplied to the reformer 33. In the reformer 33, when the mixed gas of fuel and steam is supplied, fuel gas (hydrogen, carbon monoxide) is generated by the reactions shown in the above reaction formulas F5 and F6. The fuel gas produced by the reformer 33 is supplied to the cell stack CS. This suppresses oxidation of the cell stack CS. Specifically, by supplying the fuel gas to the fuel electrode of the cell C, oxidation deterioration of the fuel electrode is suppressed.

After starting the CS reduction process, the electronic control unit 100 determines in step S130 whether or not the warm-up promotion condition is satisfied. The warm-up promotion condition is satisfied, for example, when the temperature of the cell stack CS reaches a temperature (for example, 450° C.) at which the internal resistance of the cell stack CS decreases. The electronic control unit 100 continues the CS reduction process until the warm-up promotion condition is met, and executes the warm-up promotion process in step S140, when the warm-up promotion condition is met.

The warm-up promotion process is for promoting the warm-up of various devices including the cell stack CS. The electronic control unit 100 controls the DC-DC converter (not shown) to start sweeping the current from the cell C during the warm-up promotion process. Specifically, during the warm-up promotion process, the cell C and the external circuit EC are connected to draw current to the external circuit EC. When the sweep of the current from the cell C starts, the cell C self-heats and the temperature of the cell stack CS rises. Therefore, when the cell C starts up, it is possible to accelerate the warm-up of the cell stack CS by starting to sweep the current from the cell C. When the temperature of the cell stack CS reaches a predetermined temperature (for example, 450° C.), the internal resistance of the cell stack CS gradually decreases, allowing the current from the cell C to start sweeping, but the voltage of cell C to may drop significantly due to the sweep of current from the cell C. If the voltage of the cell C drops significantly, it is not preferable because the oxidation of the anode-side electrode (that is, the fuel electrode) is accelerated. Therefore, in the warm-up promotion process of the present embodiment, the current swept from the cell C is gradually increased, and the increase in current swept from the cell C is stopped when it is detected that the voltage of the cell C is lower than a predetermined value. At this time, since the sweep of the current from the cell C is continued, the temperature of the cell stack CS rises due to self-heating of the cell C, and the internal resistance of the cell stack CS decreases. Thereby, the voltage of the cell C is improved. When it is confirmed that the voltage of the cell C has increased, the electronic control unit 100 again increases the current sweeping from the cell C. This promotes warm-up of various devices including the cell stack CS.

After starting the warm-up promotion process, the electronic control unit 100 determines in step S150 whether or not the power generation condition is satisfied. The power generation condition is met, for example, when the cell C reaches a temperature suitable for power generation by the fuel cell 10 (for example, 500° C. or higher). The electronic control unit 100 continues the warm-up promotion process until the power generation condition is satisfied. Further, when the power generation condition is satisfied, the electronic control unit 100 executes the power generation process in step S160.

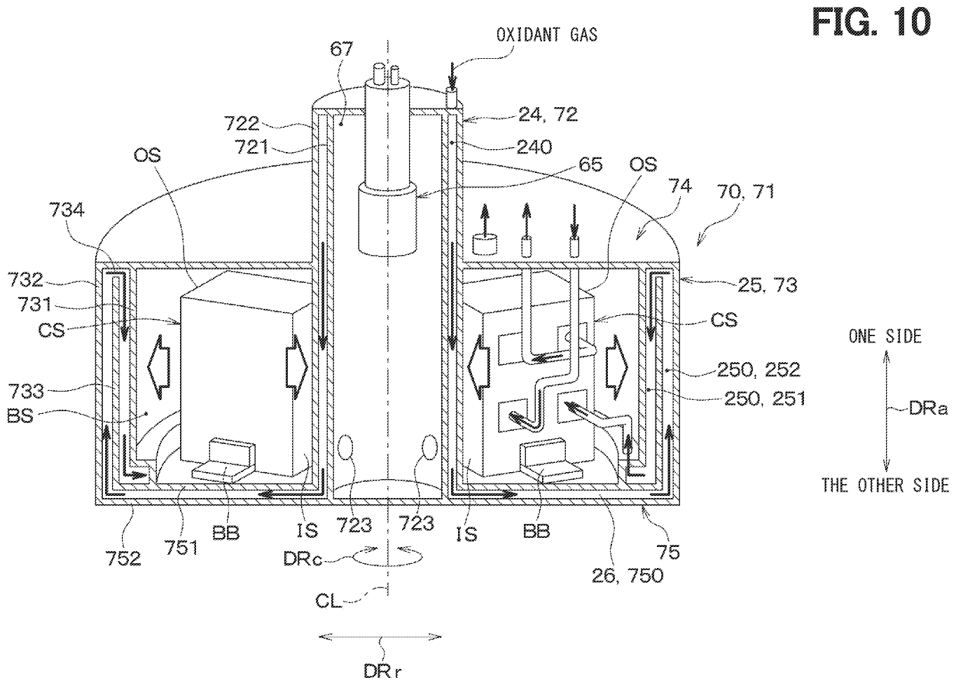

As shown in FIG. 10, the electronic control unit 100 controls the pressure feed blower 21, the fuel pump 31, and the water pump 41 so as to supply the fuel cell 10 with an amount of oxidant gas and fuel gas suitable for power generation during the power generation process. Further, the electronic control unit 100 turns off the warm-up burner 65 and the start-up blower 66 and ignites the off-gas burner 631.

Thereby, the fuel gas generated by the reformer 33 is supplied to the cell stack CS. The oxidant gas blown out from the pressure feed blower 21 flows into the air preheater 22 and the temperature of the oxidant gas raises due to heat exchange with the combustion gas. The air that has passed through the air preheater 22 flows through the first temperature control passage 240, the communication passage 740, and the second temperature control passage 250 in this order. The air passing through the first temperature control passage 240, the communication passage 740, and the second temperature control passage 250 absorbs heat from the fuel cell 10 and rises to near the battery temperature of the fuel cell 10, and then flows into the fuel cell 10. At this time, air having a low temperature and a high flow velocity flows through the first temperature control passage 240, which has a smaller heat transfer area with the cell stack CS than the second temperature control passage 250. According to this, the difference between the amount of heat transfer due to convection inside the cell stack CS in the radial direction DRr and the amount of heat transfer due to convection outside the cell stack CS in the radial direction DRr becomes small, so that the temperature distribution between the inner portion and the outer portion of the cell stack CS is reduced.

When the oxidant gas and the fuel gas are supplied to the cell stack CS, the cell C outputs electric energy through the reactions shown in the reaction formulas F1 to F4. Then, the off-gas discharged from the cell stack CS is combusted in the off-gas combustor 63 as combustible gas. The combustion gas generated by the off-gas combustor 63 dissipates heat to the reformer 33, the air preheater 22, and the water evaporator 42 when flowing through an external exhaust path (not shown).

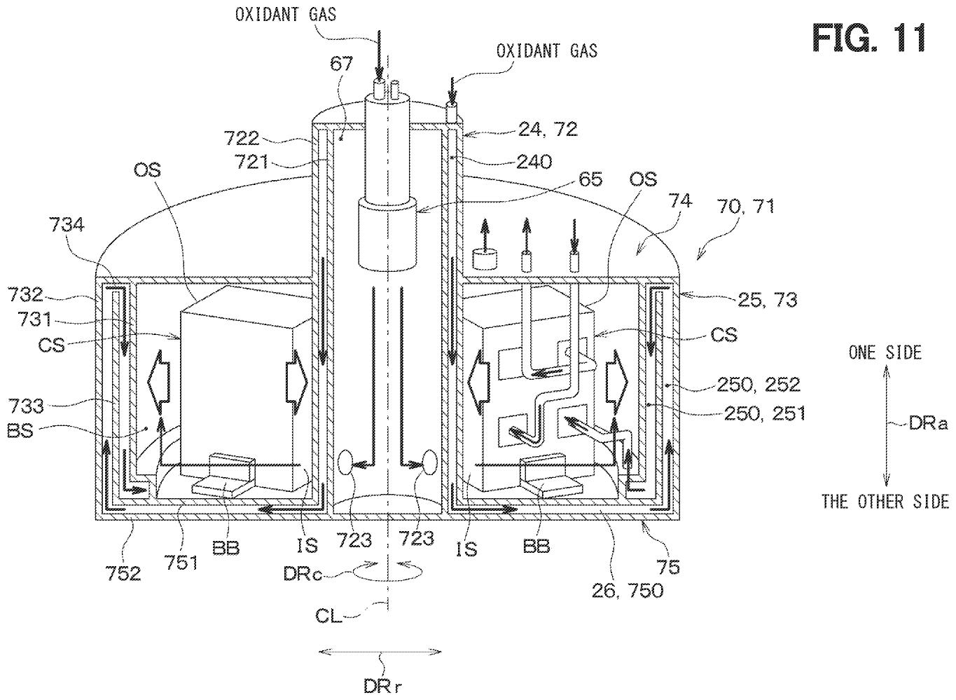

If the amount of heat generated during the power generation process increases due to deterioration over time of the cell stack CS, the temperature of the cell stack CS tends to rise excessively. In consideration of such a situation, the electronic control unit 100, as shown in FIG. 11, operates the start-up blower 66 to introduce air having a temperature lower than that of the cell stack CS into the housing space BS during the power generation process, so as to adjust the temperature of the cell stack CS to an appropriate temperature. The start-up blower 66 is turned on and off according to the temperature of the cell stack CS, for example. Further, when the temperature of the cell stack CS drops during the power generation process, the warm-up burner 65 is turned on to warm up the cell stack CS.

After starting the power generation process, the electronic control unit 100 determines in step S170 whether or not a stop condition for stopping the power generation of the fuel cell 10 is satisfied. The stop condition is satisfied, for example, when the start switch is turned off. The electronic control unit 100 continues the power generation process until the stop condition is satisfied. Further, when the stop condition is satisfied, the electronic control unit 100 executes the stop process in step S180. In this stop process, a temperature lowering process for lowering the temperature of the cell stack CS is executed. In the temperature lowering process, for example, the amount of air supplied is increased and the amount of fuel supplied is decreased, thereby lowering the temperature of the fuel cell 10 to below a temperature (for example, 300° C.) at which an oxidative deterioration of the cell stack CS occurs. This suppresses oxidation deterioration of the cell stack CS when the power generation is stopped.

In the fuel cell module 1, the warm-up burner 65 is arranged outside the housing space BS of the cell stack CS. According to this, the heat of the warm-up burner 65 is suppressed from being directly transmitted to the cell stack CS, compared to the case where the warm-up burner 65 is arranged inside the housing space BS of the cell stack CS.

In addition, the stack temperature controller 23 is arranged to face the cell stack CS with a predetermined gap, and is provided adjacent to the combustion gas passage 67. According to this, while the outside of the cell stack CS is heated by radiant heat transfer from the stack temperature controller 23, the air heated by the stack temperature controller 23 is introduced into the cell stack CS, whereby the inside of the cell stack CS can be heated.

In particular, when the stack temperature controller 23 is arranged facing the cell stack CS with a predetermined interval, the local overheating of the outside of the cell stack CS can be suppressed compared with a case where the warm-up burner 65 having a high temperature of about 900° C. is arranged close to the cell stack CS. In addition, since the air that has been heated to an appropriate temperature by the stack temperature controller 23 is introduced into the cell stack CS, the overheating of the inside of the cell stack CS can be suppressed compared with a case where the combustion gas having a high temperature of about 500° C. is directly introduced into the cell stack CS as in the prior art.

Therefore, according to the fuel cell module 1 of the present embodiment, the cell stack CS can be heated while suppressing the increase in temperature distribution between the inside and the outside of the cell stack CS. That is, it is possible to improve the startability of the cell C while ensuring the reliability of the cell stack CS. As a result, a highly reliable fuel cell module 1 that can be started in a short time can be realized.

When combustible gas such as city gas is used to generate combustion gas, the cell stack CS may be heated by introducing the combustion gas into the cell stack CS. However, if the combustion gas is introduced inside the cell stack CS, the inside of the cell stack CS is poisoned by the sulfur component contained in the combustible gas. Further, inside the cell stack CS, there is a member containing chromium (for example, a separator on the cathode side) to suppress metal oxidation. Therefore, if high-temperature combustion gas is introduced into the cell stack CS, chromium evaporates due to the heat of the combustion gas, poisoning the inside of the cell stack CS with chromium. Sulfur poisoning and chromium poisoning are unfavorable because they cause deterioration in catalytic activity and battery performance.

In contrast, the fuel cell module 1 of the present embodiment has a structure in which the oxidant gas whose temperature is raised by the stack temperature controller 23 is introduced into the cell stack CS instead of the combustion gas when the cell C is activated. Therefore, sulfur poisoning and chromium poisoning inside the cell stack CS can be avoided. Also, damage due to overheating of the warm-up burner 65 can be suppressed.

Further, according to the present embodiment, the following advantages can be obtained.

(1) The storage space BS of the cell stack CS communicates with the combustion gas passage 67 through the gas introduction hole 723, and the combustion gas that has undergone heat exchange with the oxidant gas by the stack temperature controller 23 is introduced when the cell C is started. According to this, the outside of the cell stack CS can be heated by convective heat transfer by the combustion gas introduced into the housing space BS. In particular, since the combustion gas after heat exchange with the air in the stack temperature controller 23 is introduced into the housing space BS, overheating of the outside of the cell stack CS can be suppressed.

(2) The stack temperature controller 23 includes the first temperature controller 24 adjacent to the combustion gas passage 67, the second temperature controller 25 into which the oxidant gas that has passed through the first temperature controller 24 flows, and the connection passage 26 that connects the first temperature controller 24 and the second temperature controller 25. The first temperature controller 24 is arranged between the combustion gas passage 67 and the cell stack CS. The second temperature controller 25 is arranged on the opposite side of the first temperature controller 24 across the cell stack CS. According to this, radiant heat transfer from the first temperature controller 24 and the second temperature controller 25 can heat the cell stack CS not only the portion adjacent to the first temperature controller 24 but also the portion adjacent to the second temperature controller 25. As a result, local heating of the outside of the cell stack CS can be suppressed.

(3) The stack temperature controller 23 has the gas introduction hole 723 through which the combustion gas, which has undergone heat exchange with the oxidant gas in the stack temperature controller 23 when the cell C is started, is introduced into the housing space BS. According to this, the combustion gas flowing through the combustion gas passage 67 is introduced into the housing space BS through the gas introduction hole 723 of the stack temperature controller 23 arranged facing the cell stack CS. Therefore, the heat of the combustion gas can be effectively used to heat the cell stack CS by suppressing the heat radiation of the combustion gas to the outside. It is also possible to introduce the combustion gas flowing through the combustion gas passage 67 into the housing space BS via an external pipe, however, in this case, heat of the combustion gas may be released to the outside. That is, wasteful heat dissipation of combustion gas that does not contribute to heating of the cell stack CS occurs. For this reason, it is desirable to have a structure in which the combustion gas passage 67 and the housing space BS communicate with each other through the gas introduction hole 723 provided in the stack temperature controller 23.

(4) Specifically, the housing space BS is surrounded by the first temperature controller 24, the second temperature controller 25, and the connection passage 26. The first temperature controller 24 has the gas introduction hole 723 through which the combustion gas, which has undergone heat exchange with the oxidant gas in the first temperature controller 24 when the cell C is started, is introduced into the housing space BS. According to this, the combustion gas flowing through the combustion gas passage 67 is introduced into the housing space BS through the gas introduction hole 723 of the first temperature controller 24 arranged facing the cell stack CS. Therefore, the heat of the combustion gas can be effectively used for heating the cell stack CS by suppressing the heat radiation of the combustion gas to the outside.

(5) At least the opening of the gas introduction hole 723 adjacent to the housing space BS is formed at a portion of the first temperature controller 24 that does not overlap the cell stack CS in the arrangement direction in which the first temperature controller 24 and the cell stack CS are arranged. In this manner, high-temperature combustion gas can be suppressed from being blown to a local portion of the cell stack CS by forming the opening of the gas introduction hole 723 adjacent to the housing space BS in a portion of the first temperature controller 24 that does not face the cell stack CS.

(6) The cell stacks CS are radially arranged in the housing space BS. The first temperature controller 24 is arranged to face the inner portion of the cell stack CS when the cell stacks CS are radially arranged so as to exchange heat with the inner portion. The second temperature controller 25 is arranged to face the outer portion of the cell stack CS when the cell stacks CS are radially arranged so as to exchange heat with the outer portion. According to this, the oxidant gas that exchanges heat with the high-temperature combustion gas flowing through the combustion gas passage 67 flows through the first temperature controller 24 having a smaller heat transfer area than the second temperature controller 25. As a result, when the cell stack CS is arranged radially, the difference between the amount of heat transfer due to radiation heat transfer inside the cell stack CS and the amount of heat transfer due to radiation heat transfer outside the cell stack CS becomes small. Thus, the increase in temperature distribution between the inside and the outside of the cell stack CS can be suppressed. Note that “inside the cell stack CS” means a side near the center of the cell stacks CS when the cell stacks CS are radially arranged. Further, “outside the cell stack CS” means a side away from the center of the cell stacks CS when the cell stacks CS are radially arranged.

(7) When the cell C is activated, the current sweep from the cell C is started when a predetermined condition is established after the warm-up burner 65 starts generating combustion gas. By sweeping the current from the cell C when starting the cell C, the temperature of the cell stack CS can be raised not only by the convective heat transfer of the oxidant gas inside the cell stack CS but also by the self-heating of the cell C.

(8) In the stack temperature controller 23, the temperature difference between the air flowing through the first temperature control passage 240 and the cell stack CS is greater than the temperature difference between the air flowing through the second temperature control passage 250 and the cell stack CS. Accordingly, the air flowing through the first temperature control passage 240 has a larger temperature difference from the cell stack CS than the air flowing through the second temperature control passage 250, since the heat transfer area with the cell stack CS is smaller in the first temperature control passage 240 than in the second temperature control passage 250. Therefore, the difference between the amount of heat transfer due to convection inside the cell stack CS in the radial direction DRr and the amount of heat transfer due to convection outside the cell stack CS in the radial direction DRr becomes small. Thus, the temperature distribution can be reduced between the inner portion and the outer portion of the cell stack CS in the radial direction DRr. As a result, it is possible to suppress a decrease in power generation efficiency and a decrease in durability due to the temperature distribution between the inner portion and the outer portion of the cell stack CS. Also, in the stack temperature controller 23, the cross-sectional area of the first temperature control passage 240 is smaller than the cross-sectional area of the second temperature control passage 250. According to this configuration, the air in the first temperature control passage 240 has a higher flow velocity than the air in the second temperature control passage 250, while the first temperature control passage 240 has a smaller heat transfer area with the cell stack CS than the second temperature control passage 250. Therefore, the heat transfer coefficient of the first temperature control passage 240 becomes larger than the heat transfer coefficient of the second temperature control passage 250. Therefore, the temperature distribution between the inner portion and the outer portion in the radial direction DRr of the cell stack CS can be reduced.

(9) The cell stacks CS adjacent to each other in the circumferential direction DRc are arranged in such a posture that the laminated end surfaces EF face each other. According to this configuration, since the laminated end surface EF of one of the adjacent cell stacks CS receives heat from the other cell stack CS, the temperature distribution of the cell stack CS in the stacking direction DRst can be reduced.

(10) The combustion gas passage 67 is provided inside the first temperature control passage 240 in the battery container 71. According to this configuration, for example, even when the heat generation amount of the cell stack CS increases due to deterioration over time, air having a lower temperature than the air flowing through the first temperature control passage 240 flows to the combustion gas passage 67, so that it is possible to restrict the cell stack CS from being excessively heated.

(11) The fuel gas introduction port IPH and the fuel gas outlet OPH, and the oxidant gas introduction port IPO and the oxidant gas outlet OPO are formed between the adjacent cell stacks CS. According to this configuration, the fuel gas or the oxidant gas can be supplied by effectively utilizing the space formed between the adjacent cell stacks CS. According to this configuration, the size of the container 70 can be reduced as compared with the case where a space for supplying the fuel gas or the oxidant gas is separately provided.

### Second Embodiment

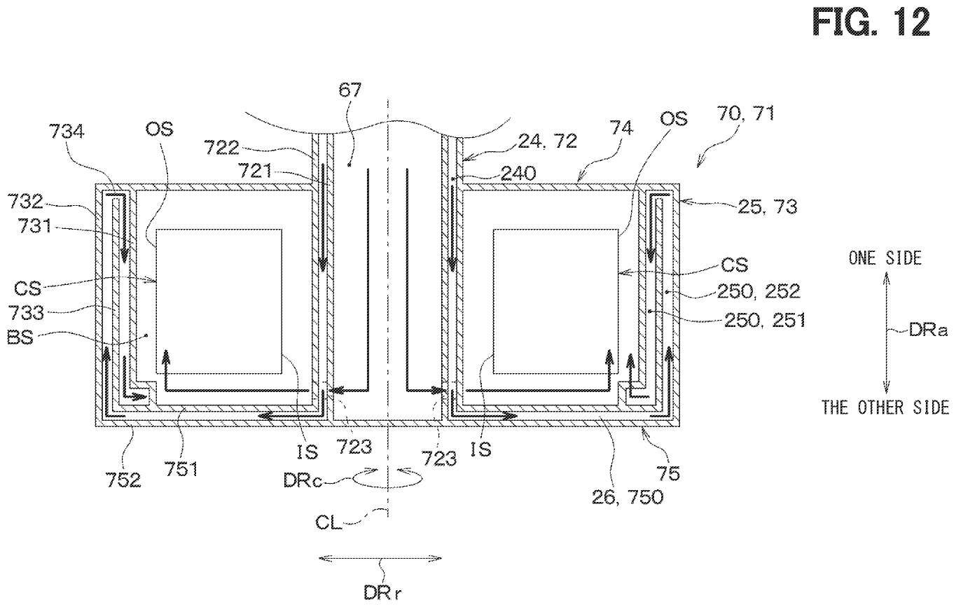

Next, a second embodiment will be described with reference to FIG. 12. In the present embodiment, differences from the first embodiment will be mainly described.

As shown in FIG. 12, in the stack temperature controller 23, the gas introduction hole 723 is formed such that the combustion gas introduced into the housing space BS from the combustion gas passage 67 flows along the connection passage 26 from the first temperature controller 24 toward the second temperature controller 25. Specifically, the gas introduction hole 723 is formed in the first temperature controller 24 at a position where at least the opening adjacent to the housing space BS corresponds to the gap formed between the cell stack CS and the connection passage 26.

The others are the same as those in the first embodiment. The fuel cell module 1 of this embodiment can obtain the same effects as those of the first embodiment due to the same or equivalent structure as that of the first embodiment. Further, according to the present embodiment, the following advantages can be obtained.

(1) As in the present embodiment, since the opening of the gas introduction hole 723 adjacent to the housing space BS is formed in a portion of the first temperature controller 24 that does not face the cell stack CS, it is possible to suppress the high-temperature combustion gas from hitting on a local site of the cell stack CS. In particular, the combustion gas introduced into the housing space BS can be guided from the first temperature controller 24 to the second temperature controller 25. Therefore, the cell stack CS can be sufficiently heated not only the side adjacent to the first temperature controller 24 but also the side adjacent to the second temperature controller 25 due to the convective heat transfer by the combustion gas introduced into the housing space BS. In addition, since the combustion gas introduced into the housing space BS flows along the connection passage 26, the combustion gas introduced into the housing space BS can exchange heat with the oxidant gas flowing through the connection passage 26. As a result, the heat exchange area between the combustion gas and the oxidant gas can be expanded, and the oxidant gas introduced into the cell stack CS can be sufficiently heated.

### Third Embodiment

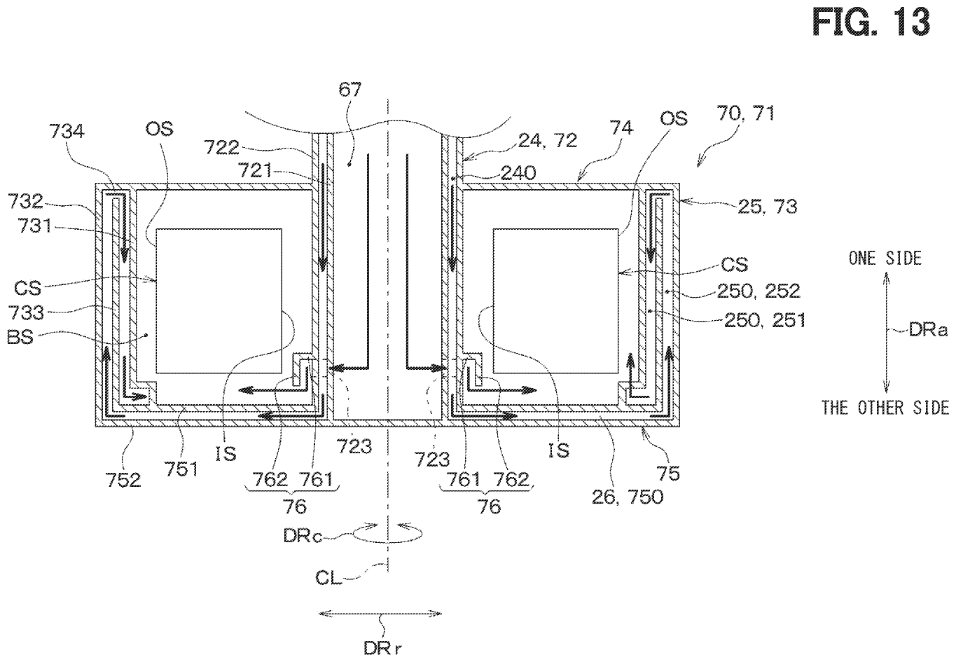

Next, a third embodiment will be described with reference to FIG. 13. In the present embodiment, differences from the first embodiment will be mainly described.

As shown in FIG. 13, the housing space BS includes a turning member 76 that turns the flow direction of the combustion gas introduced into the housing space BS through the gas introduction hole 723 to a direction other than the direction toward the cell stack CS. The turning member 76 turns the flow direction of the combustion gas introduced from the gas introduction hole 723 toward the connection passage 26 on the other side of the cell stack CS in the axial direction DRa. The turning member 76 includes an upper plate portion 761 that protrudes toward the cell stack CS from the opening of the gas introduction hole 723 adjacent to the housing space BS, and a side plate portion 762 that extends from the tip of the upper plate portion 761 toward the other side in the axial direction DRa. The side plate portion 762 is arranged between the opening of the gas introduction hole 723 adjacent to the housing space BS and the cell stack CS.

The others are the same as those in the first embodiment. The fuel cell module 1 of this embodiment can obtain the same effects as those of the first embodiment due to the same or equivalent structure as that of the first embodiment. Further, according to the present embodiment, the following advantages can be obtained.

(1) In the fuel cell module 1, the flow direction of combustion gas introduced into the housing space BS is turned by the turning member 76 to a direction other than the direction toward the cell stack CS. According to this, regardless of the opening position of the gas introduction hole 723, it is possible to suppress the high-temperature combustion gas from being blown to a local portion of the cell stack CS.

### Modification of Third Embodiment

Although the specific shape of the turning member 76 is shown in the third embodiment, the shape is not limited to this. The shape of the turning member 76 may be other shapes than those described above so as to achieve its intended purpose.

### Fourth Embodiment

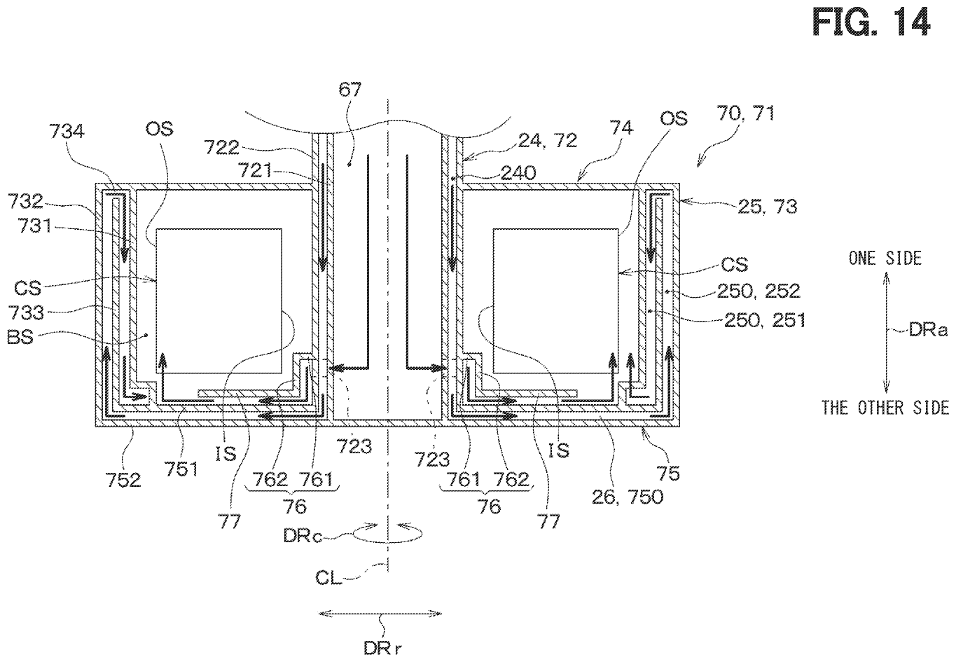

Next, a fourth embodiment will be described with reference to FIG. 14. In the present embodiment, differences from the third embodiment will be mainly described.

As shown in FIG. 14, a guide member 77 is arranged in the housing space BS to guide the combustion gas introduced into the housing space BS through the gas introduction hole 723 along the connection passage 26 from the first temperature controller 24 toward the second temperature controller 25.

Specifically, the guide member 77 has a plate-shape and extends along the connection passage 26. One end of the guide member 77 is connected to the turning member 76. The guide member 77 is arranged between the cell stack CS and the connection passage 26. The guide member 77 is not limited to being configured integrally with the turning member 76, and may be configured separately from the turning member 76.

The others are the same as those in the third embodiment. The fuel cell module 1 of the present embodiment can obtain the same effects as those of the third embodiment due to the same or equivalent configuration as the third embodiment. Further, according to the present embodiment, the following advantages can be obtained.

(1) In the fuel cell module 1, since the guide member 77 is arranged in the housing space BS, the combustion gas introduced into the housing space BS can be guided from the first temperature controller 24 to the second temperature controller 25. According to this, not only the first temperature controller 24 side but also the second temperature controller 25 side of the cell stack CS can be heated due to the convective heat transfer by the combustion gas introduced into the housing space BS. In addition, by causing the combustion gas introduced into the housing space BS to flow along the connection passage 26, the combustion gas introduced into the housing space BS can exchange heat with the oxidant gas flowing through the connection passage 26. As a result, the heat exchange area between the combustion gas and the oxidant gas can be expanded, and the oxidant gas introduced into the cell stack CS can be sufficiently heated.

### Modification of Fourth Embodiment

In the fourth embodiment, the turning member 76 and the guide member 77 are arranged in the housing space BS, but the fuel cell module 1 is not limited to this. In the fuel cell module 1, for example, as in the second embodiment, the turning member 76 may be omitted when it is not necessary to change the flow direction of the combustion gas introduced into the housing space BS.

### Fifth Embodiment

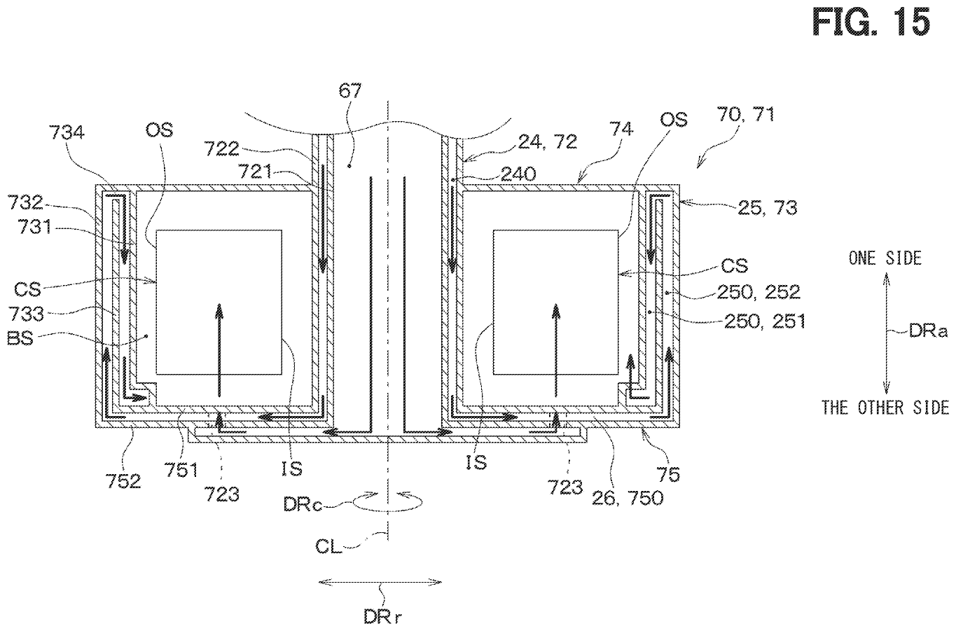

Next, a fifth embodiment will be described with reference to FIG. 15. In the present embodiment, differences from the first embodiment will be mainly described.

As shown in FIG. 15, the combustion gas passage 67 extends in the axial direction DRa along the first temperature controller 24, and the other side in the axial direction DRa extends outward in the radial direction DRr along the connection passage 26. The gas introduction hole 723 is formed in the base plate 75 forming the connection passage 26. Specifically, the gas introduction hole 723 is formed in a portion of the base plate 75 that does not face the cell stack CS in the arrangement direction in which the base plate 75 and the cell stack CS are arranged (the axial direction DRa in this embodiment). In other words, the gas introduction hole 723 is formed at a position corresponding to the gap between the adjacent cell stacks CS in the base plate 75 so that the combustion gas is introduced into the gap between the adjacent cell stacks CS.

The others are the same as those in the first embodiment. The fuel cell module 1 of this embodiment can obtain the same effects as those of the first embodiment due to the same or equivalent structure as that of the first embodiment. Further, according to the present embodiment, the following advantages can be obtained.

(1) As in the present embodiment, since the opening of the gas introduction hole 723 adjacent to the housing space BS is formed in a portion of the first temperature controller 24 that does not face the cell stack CS, the high-temperature combustion gas can be suppressed from being sprayed on the local site of the cell stack CS. In particular, since the combustion gas flows along the connection passage 26, heat exchange can be performed between the combustion gas introduced into the housing space BS and the oxidant gas flowing through the connection passage 26. As a result, the heat exchange area between the combustion gas and the oxidant gas can be expanded, and the oxidant gas introduced into the cell stack CS can be sufficiently heated.

### Sixth Embodiment

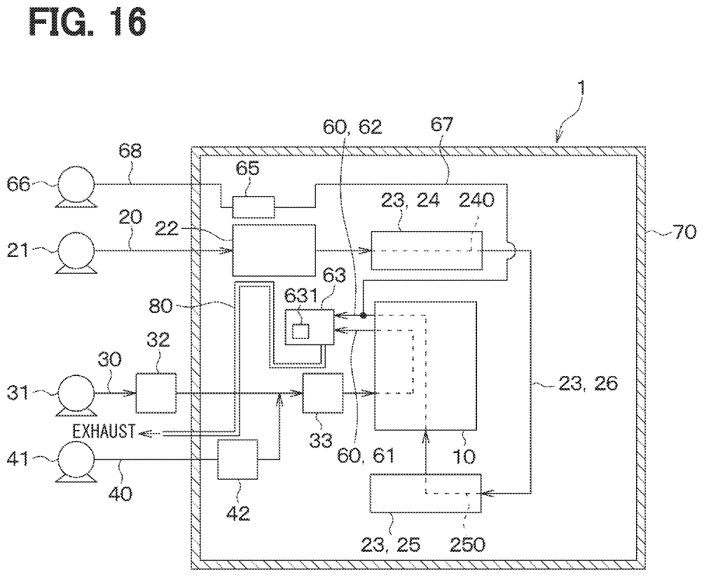

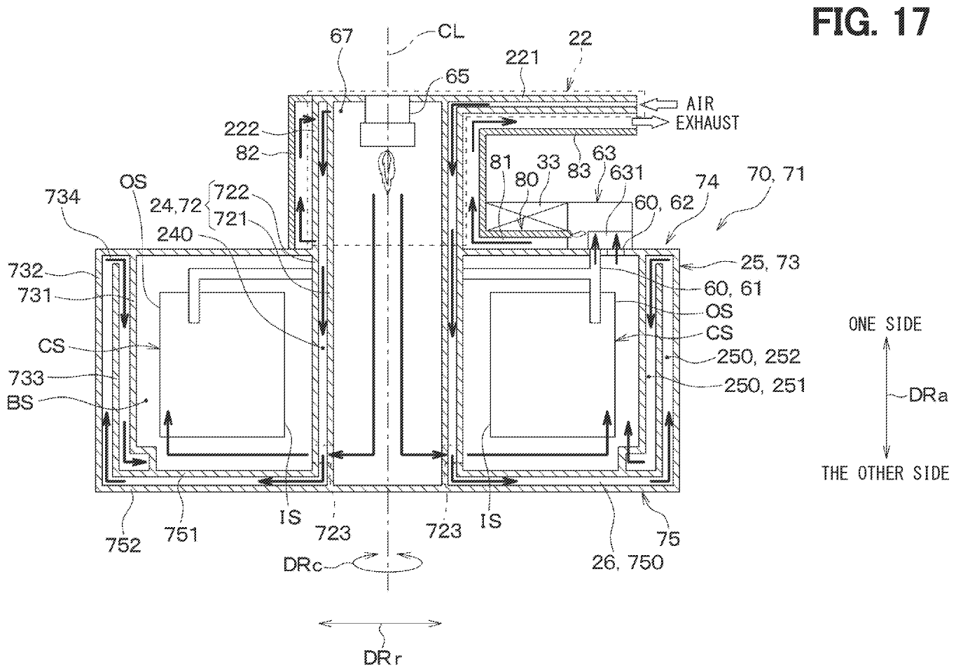

Next, a sixth embodiment will be described with reference to FIGS. 16 and 17. In the present embodiment, differences from the first embodiment will be mainly described.

As shown in FIG. 16, the off-gas combustor 63 has an off-gas burner 631 that burns the off-gas discharged from the cell stack CS to generate off-combustion-gas. The off-gas burner 631 employs a plugless burner with no ignition plug. The off-gas combustor 63 is configured as a self-ignition combustor that burns a mixed gas of fuel off-gas and oxidant off-gas by self-ignition. Note that the off-gas combustor 63 may be provided with a spark plug as a countermeasure against misfires.

The off-gas combustor 63 is connected to an external exhaust path 80 through which high-temperature combustion gas flows. The external exhaust path 80 is thermally connected to the reformer 33, the air preheater 22, the water evaporator 42, etc. in order to effectively utilize the heat of the combustion gas flowing inside. In this embodiment, the external exhaust path 80 constitutes an exhaust passage through which the off-combustion-gas generated by the off-gas burner 631 flows. The order in which the heat of the combustion gas is transferred may be changed according to the amount of heat required by each device.

The air preheater 22 is provided adjacent to the combustion gas passage 67 and the external exhaust path 80 so as to be able to receive heat from both the combustion gas and the off-combustion-gas. The air preheater 22 and the external exhaust path 80 will be described below with reference to FIG. 17.

As shown in FIG. 17, the air preheater 22 is arranged above the inner cylinder 72 of the first temperature controller 24 of the stack temperature controller 23. The air preheater 22 communicates with the inner cylinder 72. As a result, the air that has passed through the air preheater 22 is supplied to the first temperature controller 24 of the stack temperature controller 23. The air preheater 22 has an upstream pipe portion 221 located on the upstream side in the air flow and a downstream pipe portion 222 arranged downstream of the upstream pipe portion 221 and connecting the upstream pipe portion 221 and the inner cylinder 72.

The upstream pipe portion 221 is configured by a pipe extending along the radial direction DRr. The upstream pipe portion 221 is provided adjacent to the external exhaust path 80 so as to be able to receive heat from the off-combustion-gas flowing through the external exhaust path 80. The upstream pipe portion 221 of this embodiment constitutes a one-side heat receiving portion capable of receiving heat from one (off-combustion-gas in this embodiment) of the combustion gas and the off-combustion-gas. The upstream pipe portion 221 is oriented so that the flow of air and the flow of off-combustion-gas are countercurrent. The upstream pipe portion 221 is oriented so that the air flows swirling from one side to the other side in the circumferential direction around the axial center CL. The flow direction of air in the upstream pipe portion 221 may be set in the radial direction, not limited to the circumferential direction.

The downstream pipe portion 222 is configured by a pipe extending along the axial direction DRa. One end of the downstream pipe portion 222 in the axial direction DRa is connected to the upstream pipe portion 221 and the other end in the axial direction DRa is connected to the inner cylinder 72. The downstream pipe portion 222 is arranged adjacent to both the combustion gas passage 67 and the external exhaust path 80 so as to be able to receive heat from both the combustion gas and the off-combustion-gas. The downstream pipe portion 222 is provided between the external exhaust path 80 and the combustion gas passage 67 so as to be sandwiched between the external exhaust path 80 and the combustion gas passage 67. The downstream pipe portion 222 is configured in a cylindrical shape such that the combustion gas passage 67 is adjacent to the inner side of the cylindrical shape and the external exhaust path 80 is adjacent to the outer side of the cylindrical shape. The downstream pipe portion 222 constitutes a dual heat receiving portion capable of receiving heat from both the combustion gas and the off-combustion-gas. The downstream pipe portion 222 is oriented so that the air and the off-combustion-gas flow countercurrently. The downstream pipe portion 222 is oriented to flow air in a direction from one side to the other side in the axial direction DRa.

The external exhaust path 80 is provided adjacent to the reformer 33 and the air preheater 22. The external exhaust path 80 includes a first path 81 that dissipates heat to the reformer 33, a second path 82 that dissipates heat to the downstream pipe portion 222 of the air preheater 22, and a third path 83 that dissipates heat to the upstream pipe portion 221 of the air preheater 22. Although not shown, the external exhaust path 80 also includes a path for dissipating heat to the water evaporator 42.

In the fuel cell module 1 configured in this way, when the warm-up burner 65 is ignited during the start-up process of the cell C, high-temperature combustion gas is generated. This combustion gas raises the temperature of the air flowing through the air preheater 22 and the first temperature controller 24 of the stack temperature controller 23. The air whose temperature has been raised by the first temperature controller 24 flows to the second temperature controller 25 via the connection passage 26, and then is supplied to the cell stack CS. As a result, during the start-up process of the cell C, the outside of the cell stack CS is heated by radiant heat transfer from the stack temperature controller 23, and the air heated by the stack temperature controller 23 is introduced into the cell stack CS so as to heat the inside of the cell stack CS.

The high-temperature combustion gas flowing through the combustion gas passage 67 is introduced into the housing space BS via the gas introduction hole 723. Then, the outside of the cell stack CS is heated due to the convective heat transfer by the combustion gas introduced into the housing space BS. The combustion gas introduced into the housing space BS is exhausted through the air discharge path 61 of the off-gas path 60. When the combustion gas flows through the off-gas path 60, the combustion gas releases heat to the off-gas combustor 63, the reformer 33, the air preheater 22, and the water evaporator 42. Thereby, the temperature of the off-gas combustor 63, the reformer 33, the air preheater 22, and the water evaporator 42 is increased.

When the temperature inside the off-gas combustor 63 reaches the self-ignition temperature of the mixed gas of the oxidant off-gas and the combustion off-gas, the mixed gas self-ignites to generate high-temperature off-combustion-gas. This off-combustion-gas radiates heat to the reformer 33, the air preheater 22 and the water evaporator 42 when flowing through the external exhaust path 80. Thereby, the reformer 33, the air preheater 22, and the water evaporator 42 are heated.

The others are the same as those in the first embodiment. The fuel cell module 1 of this embodiment can obtain the same effects as those of the first embodiment due to the same or equivalent structure as that of the first embodiment. Further, according to the present embodiment, the following advantages can be obtained.

(1) The fuel cell module 1 includes the off-gas burner 631 that burns the off-gas discharged from the cell stack CS to generate off-combustion-gas, and the external exhaust path 80 through which the off-combustion-gas generated by the off-gas burner 631 flows. The fuel cell module 1 includes the air preheater 22 through which the oxidant gas before being supplied to the stack temperature controller 23 flows. The air preheater 22 is provided adjacent to at least one of the combustion gas passage 67 and the external exhaust path 80 so as to receive heat from at least one of combustion gas and off-combustion-gas.

In this way, since the air heated by the air preheater 22 flows into the stack temperature controller 23, the air heated to an appropriate temperature can be supplied to the stack temperature controller 23 promptly. As a result, the outside of the cell stack CS can be sufficiently heated by radiation heat transfer from the stack temperature controller 23 when the cell stack CS is started or when the temperature is low.

(2) The air preheater 22 of this embodiment includes the downstream pipe portion 222 capable of receiving heat from both combustion gas and off-combustion-gas. According to this, the air that flows into the stack temperature controller 23 can be sufficiently heated by the air preheater 22. Thereby, the outside of the cell stack CS can be sufficiently heated by radiation heat transfer from the stack temperature controller 23.

(3) Specifically, the downstream pipe portion 222 is configured in a tubular shape so that the combustion gas passage 67 is adjacent to the inside and the external exhaust path 80 is adjacent to the outside. According to this, the heat exchange area between the off-combustion-gas and the air passing through the air preheater 22 is larger than the heat exchange area between the combustion gas and the air passing through the air preheater 22. That is, the heat exchange area between the off-combustion-gas and the air passing through the air preheater 22 can be secured.

In particular, since the air preheater 22 of the present embodiment is provided with the upstream pipe portion 221 adjacent to the external exhaust path 80, the heat exchange area between the off-combustion-gas and the air passing through the air preheater 22 can be secured sufficiently large. Accordingly, it is possible to appropriately raise the temperature of the air passing through the air preheater 22 not only when the cell stack CS is started, but also when the fuel cell 10 is generating power.

In addition, in the air preheater 22, heat is exchanged between the combustion gas and the air passing through the air preheater 22 in the downstream pipe portion 222, and heat is exchanged between the off combustion gas and the air passing through the air preheater 22 in both the upstream pipe portion 221 and the downstream pipe portion 222. Therefore, in the air preheater 22, the heat exchange area between the combustion gas and the air passing through the air preheater 22 is smaller than the heat exchange area between the off-combustion-gas and the air passing through the air preheater 22. According to this, for example, when the warm-up burner 65 is turned off, unintended heat exchange can be suppressed between the combustion gas passage 67 and the air preheater 22, while the temperature of the combustion gas passage 67 becomes low such that heat tends to emitted from the air preheater 22 to the combustion gas passage 67.

### Modification of Sixth Embodiment

One of the upstream pipe portion 221 and the downstream pipe portion 222 of the air preheater 22 may be omitted. That is, the air preheater 22 may be provided adjacent to one of the combustion gas passage 67 and the external exhaust path 80 so as to receive heat from one of the combustion gas and the off-combustion-gas. Further, the shapes of the upstream pipe portion 221 and the downstream pipe portion 222 are not limited to those shown in FIG. 17, and may be different from those shown in FIG. 17.

The air preheater 22 of the sixth embodiment has a structure in which the upstream side of the air flow exchanges heat with the combustion gas, and the downstream side of the air flow exchanges heat with both the combustion gas and the off-combustion-gas, but not limited to this. The air preheater 22 may be configured, for example, such that heat is exchanged with both the combustion gas and the off-combustion-gas on the upstream side of the air flow and that heat is exchanged with the off-combustion-gas on the downstream side of the air flow.

Although the air preheater 22 is exemplified so that the flow direction of air is set such that the air flow and the off-combustion-gas flow are countercurrent, the air preheater 22 is not limited to this. The air preheater 22 may be oriented, for example, so that the air flow and the off-combustion-gas flow are parallel or perpendicular with each other.

Although the air preheater 22 is exemplified so that the flow direction of air is set such that the air flow and the off-combustion-gas flow are countercurrent, the air preheater 22 is not limited to this. The air preheater 22 may be oriented, for example, so that the air flow and the off-combustion-gas flow are co-flow or cross-flow.

The air preheater 22 and the external exhaust path 80 described in the sixth embodiment can be applied not only to the first embodiment, but also to the fuel cell module 1 described in the second to fifth embodiments, for example.

In the air preheater 22, the heat exchange area between the off-combustion-gas and the air passing through the air preheater 22 is larger than the heat exchange area between the combustion gas and the air passing through the air preheater 22, but is not limited to this. The air preheater 22 is configured, for example, so that the heat exchange area between the off-combustion-gas and the air passing through the air preheater 22 is equal to or smaller than the heat exchange area between the combustion gas and the air passing through the air preheater 22.

### Seventh Embodiment

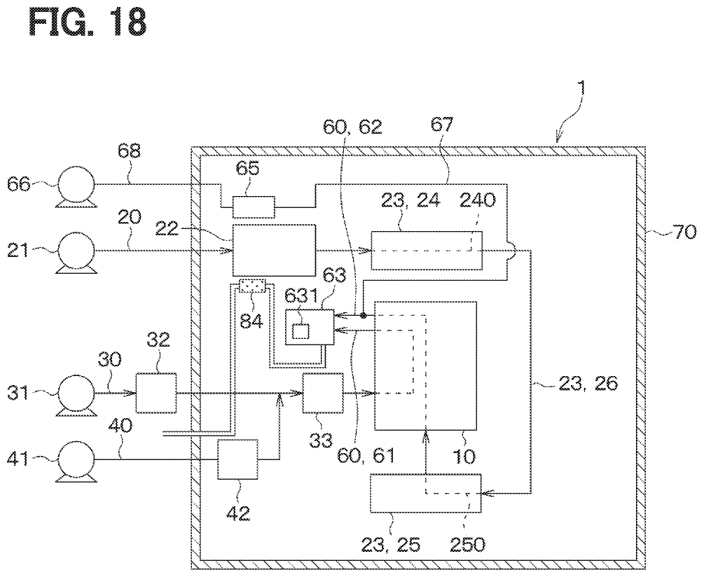

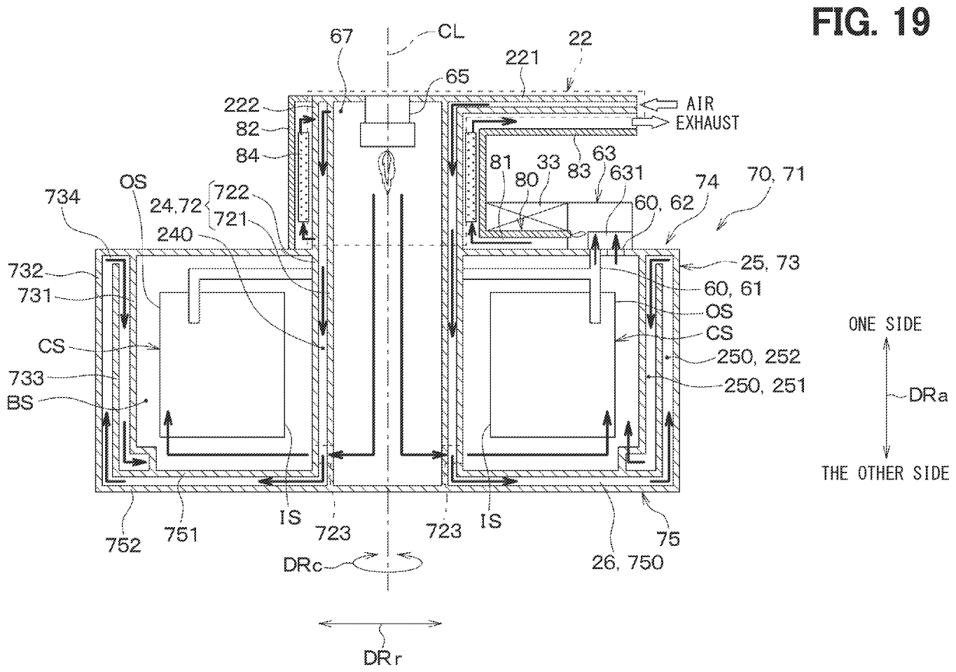

Next, a seventh embodiment will be described with reference to FIGS. 18 and 19. In the present embodiment, differences from the sixth embodiment will be mainly described.

As in the sixth embodiment, when the off-gas combustor 63 is configured as a self-ignition combustor, there is a concern that the unreacted fuel containing hydrogen may flow out through the external exhaust path 80 until the mixed gas of fuel off-gas and oxidant off-gas self-ignites.

In consideration of this, as shown in FIG. 18, a combustion catalyst 84 for burning unreacted fuel contained in the off-combustion-gas is arranged in the external exhaust path 80 of the present embodiment. The combustion catalyst 84 may be, for example, an oxidation catalyst that oxidizes unreacted fuel.

The catalytic reaction of the combustion catalyst 84 is activated in a high-temperature atmosphere. For this reason, in the present embodiment, the combustion catalyst 84 is arranged at a part of the external exhaust path 80 that becomes hot. That is, the combustion catalyst 84 is arranged at a position of the external exhaust path 80 adjacent to a heat receiving portion of the air preheater 22 that can receive heat from the combustion gas.

Specifically, as shown in FIG. 19, the combustion catalyst 84 is arranged in the second path 82 of the external exhaust path 80 adjacent to the downstream pipe portion 222 of the air preheater 22. Note that, in the present embodiment, the downstream pipe portion 222 constitutes the heat receiving portion capable of receiving heat from the combustion gas in the air preheater 22.

In the fuel cell module 1 configured in this manner, unreacted fuel passes through the off-gas combustor 63 and flows to the external exhaust path 80 until the mixed gas of the fuel off-gas and the oxidant off-gas self-ignites. Unreacted fuel is combusted by the combustion catalyst 84 while flowing through the external exhaust path 80. Therefore, unreacted fuel containing hydrogen is restricted from flowing out through the external exhaust path 80.

Further, when the off-combustion-gas contains unreacted fuel, reaction heat is generated due to the catalytic reaction of the combustion catalyst 84. A part of this heat of reaction is radiated to the air flowing through the air preheater 22 adjacent to the downstream tube portion 222 in which the combustion catalyst 84 is arranged.

The others are the same as those in the sixth embodiment. The fuel cell module 1 of the present embodiment can obtain the same effects as those of the sixth embodiment due to the same or equivalent structure as that of the sixth embodiment. Further, according to the present embodiment, the following advantages can be obtained.

(1) The combustion catalyst 84 is disposed in the external exhaust path 80 to burn unreacted fuel contained in the off-combustion-gas. According to this, it is possible to suppress the unreacted fuel contained in the off-combustion-gas from being exhausted to the outside as it is.

(2) The combustion catalyst 84 is arranged in a portion of the external exhaust path 80 adjacent to the heat receiving portion of the air preheater 22 that can receive heat from the combustion gas. According to this, since the heat of the catalytic reaction of the combustion catalyst 84 can be used to raise the temperature of the air passing through the air preheater 22, the air flowing into the stack temperature controller 23 can be sufficiently heated by the air preheater 22.

Since the catalytic reaction of the combustion catalyst 84 is an exothermic reaction, some heat resistance measures are required to prevent the combustion catalyst 84 from overheating. In the present embodiment, the combustion catalyst 84 is provided at a portion of the external exhaust path 80 adjacent to the air preheater 22. Therefore, the reaction heat generated by the catalytic reaction of the combustion catalyst 84 is radiated to the air passing through the air preheater 22, so that overheating of the combustion catalyst 84 can be suppressed. Using the air preheater 22 as a countermeasure against the heat resistance of the combustion catalyst 84 in this manner reduces the number of parts compared to the case of adding a dedicated product for the heat resistance countermeasure of the combustion catalyst 84. Thus, the fuel cell module 1 can be simplified in the module configuration.

### Modification of Seventh Embodiment

In the seventh embodiment, the combustion catalyst 84 is arranged in the external exhaust path 80 at a position adjacent to the heat receiving portion capable of receiving heat from the combustion gas in the air preheater 22, but may be placed in a different position.

The combustion catalyst 84 may be arranged, for example, in a portion of the external exhaust path 80 that dissipates heat to the reformer 33. That is, the combustion catalyst 84 may be arranged in the first path 81 of the external exhaust path 80. According to this, the reaction heat of the catalytic reaction of the combustion catalyst 84 can be used to raise the temperature of the reformer 33, so the temperature of the reformer 33 can be raised quickly. In addition, since the off-combustion-gas whose temperature has been raised by the reaction heat generated by the catalytic reaction of the combustion catalyst 84 flows through the second path 82 that exchanges heat with the air preheater 22, the air that flows into the stack temperature controller 23 can be sufficiently heated by the air preheater 22.

Since the catalytic reaction of the reformer 33 is an endothermic reaction, a part of the reaction heat due to the catalytic reaction of the combustion catalyst 84 is absorbed by the reformer 33. As a result, overheating of the combustion catalyst 84 is suppressed.

Further, the combustion catalyst 84 may be arranged, for example, in a portion of the external exhaust path 80 that dissipates heat to the water evaporator 42. According to this, the reaction heat of the catalytic reaction of the combustion catalyst 84 can be used to raise the temperature of the water evaporator 42, so the temperature of the water evaporator 42 can be raised early. Also, overheating of the combustion catalyst 84 is suppressed by the latent heat of vaporization in the water evaporator 42.

### Other Embodiments

Although the representative embodiments of the present disclosure have been described above, the present disclosure is not limited to the above embodiments, and can be variously modified, for example, as follows.

In the embodiment, the gas introduction hole 723 is formed in a portion of the stack temperature controller 23 that does not face the cell stack CS, but the formation position of the gas introduction hole 723 is not limited to this. The gas introduction hole 723 may be formed in a portion of the stack temperature controller 23 facing the cell stack CS. For example, at least one of the opening adjacent to the combustion gas passage 67 and the opening adjacent to the housing space BS, in the gas introduction hole 723, may be formed at a position facing the cell stack CS in the inner cylinder 72.

In the embodiment, the combustion gas is introduced into the housing space BS of the cell stack CS, but the fuel cell module 1 is not limited to this. For example, the fuel cell module 1 may be arranged such that combustion gas is not introduced into the housing space BS of the cell stack CS.

In the embodiment, the stack temperature controller 23 has the first temperature controller 24, the second temperature controller 25, and the connection passage 26, but the stack temperature controller 23 is not limited to this. The stack temperature controller 23 may, for example, not have the second temperature controller 25 and the connection passage 26 or may have the third temperature controller provided in the upper lid 74. Moreover, the second temperature control passage 250 has a flow path structure in which the air passing through the outer flow path portion 252 turns back and flows into the inner flow path portion 251, but is not limited to this. For example, the flow path structure of the second temperature control passage 250 may have only the outer flow path portion 252.

In the embodiment, the cell stacks CS are arranged radially in the housing space BS, but the arrangement form of the cell stacks CS is not limited to this. The cell stacks CS may be arranged side by side, for example in the axial direction DRa or the radial direction DRr. In this case, the battery container 71 may have a shape that matches the arrangement of the cell stacks CS. The number of the cell stacks CS arranged in the housing space BS is not limited to the above. For example, a single cell stack CS may be arranged in the housing space BS.

In the embodiment, in the starting process of the cell C, when a predetermined condition is established after the warm-up burner 65 starts generating the combustion gas, the sweep of the current from the cell C is started. The starting process of the cell C is not limited to this. In the starting process of the cell C, for example, the current from the cell C may not be swept.

In the embodiment, the battery container 71 has a double cylinder structure in which the donut-shaped storage space BS is formed inside. However, the battery container 71 is not limited to this structure, and may have other structure other than the double cylinder structure.

In the embodiment, the battery container 71 is arranged in a posture extending along the vertical direction, but the arrangement posture of the battery container 71 is not limited to this structure. The battery container 71 may be arranged, for example, in a posture tilted with respect to the vertical direction.

In the embodiment, the fuel cell 10 is arranged in a space separate from the space in which the air preheater 22, the reformer 33, the water evaporator 42, the off-gas combustor 63, etc. are housed. The arrangement of the fuel cell 10 is not limited to this. The fuel cell 10 may be arranged in the same space as the space in which, for example the air preheater 22, the reformer 33, the water evaporator 42, the off-gas combustor 63, etc. are housed.

In the embodiment, the inlet for fuel gas and oxidant gas is provided between the adjacent cell stacks CS, but the arrangement of the inlet is not limited to this configuration. The inlet for fuel gas and oxidant gas may be provided at another position other than between the adjacent cell stacks CS.

In the embodiment, the fuel cell module 1 of the present disclosure is applied to a fuel cell system having the solid oxide fuel cell 10, but the application target of the fuel cell module 1 is not limited to this configuration. The fuel cell module 1 can be widely applied to a system including another fuel cell such as fuel cell having a solid electrolyte membrane (that is, PEFC).

In the embodiments described above, it is needless to say that the elements configuring the embodiments are not necessarily essential except in the case where those elements are clearly indicated to be essential in particular, the case where those elements are considered to be obviously essential in principle, and the like.

In the embodiments described above, the present disclosure is not limited to the specific number of components of the embodiments, except when numerical values such as the number, numerical values, quantities, ranges, and the like are referred to, particularly when it is expressly indispensable, and when it is obviously limited to the specific number in principle, and the like.

In the embodiments described above, when referring to the shape, positional relationship, and the like of a component and the like, the present disclosure is not limited to the shape, positional relationship, and the like, except for the case of being specifically specified, the case of being fundamentally limited to a specific shape, positional relationship, and the like.

The control unit and techniques of the present disclosure may be implemented on a dedicated computer provided by configuring a processor and memory programmed to perform one or more functions embodied by the computer program. The control unit and techniques of the present disclosure may be implemented in a dedicated computer provided by configuring the processor with one or more dedicated hardware logic circuits. The control unit and method of the present disclosure may be implemented on one or more dedicated computers that is a combination of a processor and memory programmed to perform one or more functions and a processor configured by one or more hardware logic circuits. The computer program may be stored in a computer-readable non-transition tangible recording medium as an instruction executed by a computer.

What is claimed is:

1. A fuel cell module comprising:
a cell stack in which a plurality of fuel cells are stacked so as to output electrical energy through an electrochemical reaction between a fuel gas and an oxidant gas;
a stack temperature controller through which the oxidant gas before being supplied to the cell stack flows; and
a warm-up burner configured to generate a combustion gas to warm up the cell stack, wherein
the warm-up burner is arranged outside a housing space in which the cell stack is arranged,
the stack temperature controller is arranged to face the cell stack with a predetermined gap therebetween so as to allow heat exchange with the cell stack, and is located adjacent to a combustion gas passage through which the combustion gas generated by the warm-up burner flows so as to allow heat exchange between the oxidant gas flowing through the stack temperature controller and the combustion gas generated by the warm-up burner,
the stack temperature controller includes
a first temperature controller adjacent to the combustion gas passage,
a second temperature controller into which the oxidant gas that has passed through the first temperature controller flows, and
a connection passage that connects the first temperature controller and the second temperature controller,
the first temperature controller is arranged between the combustion gas passage and the cell stack,
the second temperature controller is arranged opposite to the first temperature controller through the cell stack,
the warm-up burner burns combustible gas to generate the combustion gas, and
the combustion gas generated by the warm-up burner is supplied to the combustion gas passage and the combustion gas flowing through the combustion gas passage is introduced into the housing space.

2. The fuel cell module according to claim 1, wherein
the housing space communicates with the combustion gas passage, and receives the combustion gas that has undergone heat exchange with the oxidant gas in the stack temperature controller.

3. The fuel cell module according to claim 1, wherein
the stack temperature controller has a gas introduction hole to introduce the combustion gas that has undergone heat exchange with the oxidant gas in the stack temperature controller, into the housing space.

4. The fuel cell module according to claim 1, wherein
the housing space is surrounded by the first temperature controller, the second temperature controller, and the connection passage, and
the first temperature controller has a gas introduction hole to introduce the combustion gas that has undergone heat exchange with the oxidant gas in the first temperature controller, into the housing space.

5. The fuel cell module according to claim 4, wherein
the gas introduction hole has an opening located adjacent to the housing space, and the opening is formed at a portion of the first temperature controller that does not overlap with the cell stack in an arrangement direction in which the first temperature controller and the cell stack are arranged.

6. The fuel cell module according to claim 4, further comprising:
a turning member arranged in the housing space to turn a flow direction of the combustion gas introduced into the housing space through the gas introduction hole to a direction other than a direction toward the cell stack.

7. The fuel cell module according to claim 4, further comprising:
a guide member arranged in the housing space to guide the combustion gas introduced into the housing space through the gas introduction hole along the connection passage from the first temperature controller toward the second temperature controller.

8. The fuel cell module according to claim 4, wherein
the cell stack is one of a plurality of cell stacks radially arranged in the housing space,
the first temperature controller is arranged to face an inner portion of the cell stack so as to exchange heat with the inner portion of the cell stack when the plurality of cell stacks are radially arranged, and
the second temperature controller is arranged to face an outer portion of the cell stack so as to exchange heat with the outer portion of the cell stack when the plurality of cell stacks are radially arranged.

9. The fuel cell module according to claim 1, wherein
when the fuel cell is activated, a current sweeping from the fuel cell is started when a predetermined condition is satisfied after the warm-up burner has started generating the combustion gas.

10. The fuel cell module according to claim 1, further comprising:
an off-gas burner configured to burn an off-gas discharged from the cell stack to generate an off-combustion-gas;
an exhaust passage through which the off-combustion-gas generated by the off-gas burner flows; and
an air preheater through which the oxidant gas before being supplied to the stack temperature controller flows, wherein
the air preheater is provided adjacent to at least one of the combustion gas passage and the exhaust passage so as to receive heat from at least one of the combustion gas and the off-combustion-gas.

11. The fuel cell module according to claim 10, wherein the air preheater includes a dual heat receiving site capable of receiving heat from both the combustion gas and the off-combustion-gas.

12. The fuel cell module according to claim 11, wherein the dual heat receiving site is configured in a cylindrical shape so that the combustion gas passage is adjacent to an inner side of the dual heat receiving site and the exhaust passage is adjacent to an outer side of the dual heat receiving site.

13. The fuel cell module according to claim 10, further comprising: a combustion catalyst to burn an unreacted fuel contained in the off-combustion-gas in the exhaust passage.

14. The fuel cell module according to claim 13, wherein the combustion catalyst is arranged in the exhaust passage at a position adjacent to a heat receiving portion of the air preheater capable of receiving heat from the combustion gas.
